(19) United States
(12) Patent Application Publication
(10) Pub. No.: US 2025/0093887 A1
(43) Pub. Date: Mar. 20, 2025

(54) ROUTE GENERATION SYSTEM AND ROUTE GENERATION METHOD FOR AUTOMATED TRAVEL OF AGRICULTURAL MACHINE

(71) Applicant: Kubota Corporation, Osaka (JP)

(72) Inventors: Keigo KOMARU, Sakai-shi (JP); Toru TAMBO, Sakai-shi (JP); Takashi NISHIYAMA, Sakai-shi (JP); Yoshihiro WATANABE, Sakai-shi (JP); Takashi ISHIZAKI, Sakai-shi (JP); Ken SAKUTA, Sakai-shi (JP); Megumi SUZUKAWA, Sakai-shi (JP); Wataru MORIMOTO, Sakai-shi (JP); Kenji ISHIHARA, Sakai-shi (JP)

(21) Appl. No.: 18/969,460

(22) Filed: Dec. 5, 2024

Related U.S. Application Data
(63) Continuation of application No. PCT/JP2023/019921, filed on May 29, 2023.

(30) Foreign Application Priority Data
Jun. 8, 2022 (JP) 2022-093143

(51) Int. Cl. G05D 1/693; G05D 1/243; G05D 1/248; G05D 105/15; G05D 107/20; G05D 111/10

(52) U.S. Cl. CPC G05D 1/693; G05D 1/243; G05D 1/248; G05D 2105/15; G05D 2107/21; G05D 2111/10

(57) ABSTRACT

A route generation system for automated travel of an agricultural machine includes a processor configured or programmed to generate an automated travel route of the agricultural machine. The processor is configured or programmed to acquire, from a vehicle that manually travels along a route that the agricultural machine is scheduled to travel automatically while recording a travel path, data representing the travel path; remove, from the travel path, a path associated with an avoidance action performed to avoid an oncoming vehicle; and generate an automated travel route of the agricultural machine based on the travel path from which the path associated with the avoidance action has been removed.

### CROSS REFERENCE TO RELATED APPLICATIONS

This application claims the benefit of priority to Japanese Patent Application No. 2022-093143 filed on Jun. 8, 2022 and is a Continuation Application of PCT Application No. PCT/JP2023/019921 filed on May 29, 2023. The entire contents of each application are hereby incorporated herein by reference.

### BACKGROUND OF THE INVENTION

### 1. Field of the Invention

The present disclosure relates to route generation systems and route generation methods for automated travel of agricultural machines.

### 2. Description of the Related Art

Research and development have been directed to the automation of agricultural machines to be used in agricultural fields. For example, work vehicles, such as tractors, combines, and rice transplanters, which automatically travel within fields by utilizing a positioning system, e.g., a GNSS (Global Navigation Satellite System), are coming into practical use. Research and development are also under way for work vehicles which automatically travel not only within fields, but also outside the fields.

Japanese Laid-Open Patent Publications No. 2021-073602 and Japanese Laid-Open Patent Publications No. 2021-029218 each disclose an example of system to cause an unmanned work vehicle to automatically travel between two fields separated from each other with a road being sandwiched therebetween.

### SUMMARY OF THE INVENTION

In order to realize an agricultural machine that performs automated travel, it is necessary to generate an automated travel route in advance. The present disclosure provides example embodiments and techniques to properly generate an automated travel route for an agricultural machine.

A route generation system according to an example embodiment of the present disclosure is a route generation system for automated travel of an agricultural machine, the system including a processor configured or programmed to generate an automated travel route of the agricultural machine. The processor is configured or programmed to acquire, from a vehicle that manually travels along a route that the agricultural machine is scheduled to travel automatically while recording a travel path, data representing the travel path; remove, from the travel path, a path associated with an avoidance action performed to avoid an oncoming vehicle; and generate an automated travel route of the agricultural machine based on the travel path from which the path associated with the avoidance action has been removed.

A route generation method according to another example embodiment of the present disclosure is a route generation method for automated travel of an agricultural machine, the method including acquiring, from a vehicle that manually travels along a route that the agricultural machine is scheduled to travel automatically while recording a travel path, data representing the travel path; removing, from the travel path, a path associated with an avoidance action performed to avoid an oncoming vehicle; and generating an automated travel route of the agricultural machine based on the travel path from which the path associated with the avoidance action has been removed.

Example embodiments of the present disclosure may be realized by apparatuses, systems, methods, integrated circuits, computer programs, or computer readable non-transitory storage media, or any combination thereof. The computer readable storage media may include a volatile storage media or a nonvolatile storage media. The apparatuses may each include a plurality of apparatuses. If an apparatus includes two or more apparatuses, the two or more apparatuses may be provided within a single device or may be provided separately within two or more separate devices.

According to example embodiments of the present disclosure, an automated travel route for an agricultural machine can be properly generated.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a block diagram showing an example of a route generation system.

FIG. 2 is a block diagram showing an example of a more detailed configuration of the route generation system.

FIG. 3 is a diagram schematically showing a vehicle traveling on a road outside a field while collecting data.

FIG. 4 is a flow chart showing an example of an operation of generating an automated travel route.

FIG. 5A is a diagram showing an example of an operation in which a vehicle avoids an oncoming vehicle.

FIG. 5B is a diagram showing an example of a travel path from which a path associated with the avoidance action is removed.

FIG. 5C is a diagram showing a process of complementing the portion that has been removed from the travel path with a straight complementing route.

FIG. 6 is a diagram showing another example of an operation in which a vehicle avoids an oncoming vehicle.

FIG. 7A is a diagram showing an example of a display on a display.

FIG. 7B is a diagram showing an example of a display screen when a user touches one of dotted-line encircled portions.

FIG. 7C is a diagram showing an example of a display screen when one of the removed sections is complemented.

FIG. 7D is a diagram showing an example of a display screen when all the removed sections are complemented to complete an automated travel route.

FIG. 8 is a diagram illustrating an overview of an agricultural management system according to an example embodiment of the present disclosure.

FIG. 9 is a side view schematically showing an example of a work vehicle and an implement connected to the work vehicle.

FIG. 10 is a block diagram showing an example configuration of a work vehicle and an implement.

FIG. 11 is a conceptual diagram showing an example of a work vehicle performing positioning using RTK-GNSS.

FIG. 12 is a diagram showing an example of an operation terminal and operation switches provided inside the cabin.

FIG. 13 is a block diagram illustrating an example of the general hardware configuration of the management device and the terminal device.

FIG. 14 is a diagram schematically showing an example of a work vehicle that automatically travels along a target path in a field.

FIG. 15 is a flow chart showing an example of a steering control operation during automated driving executed by a controller.

FIG. 16A is a diagram showing an example of a work vehicle traveling along a target path.

FIG. 16B is a diagram showing an example of a work vehicle located at a position shifted to the right from the target path.

FIG. 16C is a diagram showing an example of a work vehicle located at a position shifted to the left from the target path.

FIG. 16D is a diagram showing an example of a work vehicle facing a direction inclined with respect to the target path.

### DETAILED DESCRIPTION OF THE EXAMPLE EMBODIMENTS

In the present disclosure, an “agricultural machine” refers to a machine for agricultural applications. Examples of agricultural machines include tractors, harvesters, rice transplanters, vehicles for crop management, vegetable transplanters, mowers, seeders, spreaders, and mobile robots for agriculture. Not only may a work vehicle such as a tractor function as an “agricultural machine” alone by itself, but also a combination of a work vehicle and an implement that is attached to, or towed by, the work vehicle may function as an “agricultural machine”. For the ground surface inside a field, the agricultural machine performs agricultural work such as tilling, seeding, preventive pest control, manure spreading, planting of crop, or harvesting. Such agricultural work or tasks may be referred to as “groundwork”, or simply as “work” or “tasks”. Travel of a vehicle-type agricultural machine performed while the agricultural machine also performs agricultural work may be referred to as “tasked travel”.

“Automated driving” refers to controlling the movement of an agricultural machine by the action of a controller, rather than through manual operations of a driver. An agricultural machine that performs automated driving may be referred to as an “automated driving agricultural machine” or a “robotic agricultural machine”. During automated driving, not only the movement of the agricultural machine, but also the operation of agricultural work (e.g., the operation of an implement) may be controlled automatically. In the case where the agricultural machine is a vehicle-type machine, travel of the agricultural machine via automated driving will be referred to as “automated travel”. The controller may be configured or programmed to control at least one of steering that is required in the movement of the agricultural machine, adjustment of the moving speed, or beginning and ending of a move. In the case of controlling a work vehicle having an implement attached thereto, the controller may be configured or programmed to control raising or lowering of the implement, beginning and ending of an operation of the implement, and so on. A move based on automated driving may include not only moving of an agricultural machine that goes along a predetermined path toward a destination, but also moving of an agricultural machine that follows a target of tracking. An agricultural machine that performs automated driving may also move partly based on the user's instructions. Moreover, an agricultural machine that performs automated driving may operate not only in an automated driving mode but also in a manual driving mode, where the agricultural machine moves through manual operations of the driver. When performed not manually but through the action of a controller, the steering of an agricultural machine will be referred to as “automatic steering”. A portion of, or the entirety of, the controller may reside outside the agricultural machine. Control signals, commands, data, etc., may be communicated between the agricultural machine and a controller existing outside the agricultural machine. An agricultural machine that performs automated driving may move autonomously while sensing the surrounding environment, without any person being involved in the controlling of the movement of the agricultural machine. An agricultural machine that is capable of autonomous movement is able to travel inside the field or outside the field (e.g., on roads) in an unmanned manner. During an autonomous move, operations of detecting and avoiding obstacles may be performed.

An “environment map” is data that representing with a predetermined coordinate system, the position or the region of an object existing in the environment where the agricultural machine moves. The environment map may be referred to simply as a “map” or “map data”. The coordinate system defining the environment map may be a world coordinate system such as a geographic coordinate system fixed to the globe, for example. The environment map may include information other than the position (e.g., attribute information or other types of information) for objects that are present in the environment. The environment map encompasses various types of maps, such as a point cloud map or a grid map. Data on a local map or a partial map that is generated or processed in a process of constructing the environment map is also referred to as a “map” or “map data”.

“Automated travel route” means data of a route connecting a starting point and a destination point when an agricultural machine travels automatically. An automated travel route may also be called a “global path” or a “target path”. An automated travel route can be defined, for example, by the coordinate values of a plurality of points on a map that the agricultural machine should pass through. The points that the agricultural machine should pass through are called “waypoints”, and the line segments connecting adjacent waypoints are called “links”. The waypoint data may include information on position and speed. In the present specification, the generation of data (e.g., data of a plurality of waypoints) that represents an automated travel route is expressed as “generating an automated travel route”.

Hereinafter, example embodiments of the present disclosure will be described. Note, however, that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. The accompanying drawings and the following description are not intended to limit the scope of the claims. In the following description, elements having identical or similar functions are denoted by identical reference numerals.

The following example embodiments are only exemplary, and the techniques according to the present disclosure are not limited to the following example embodiments. For example, numerical values, shapes, materials, steps, orders of steps, layout of a display screen, etc., which are indicated in the following example embodiments are only exemplary, and admit of various modifications so long as it makes technological sense. Any one implementation may be combined with another so long as it makes technological sense to do so.

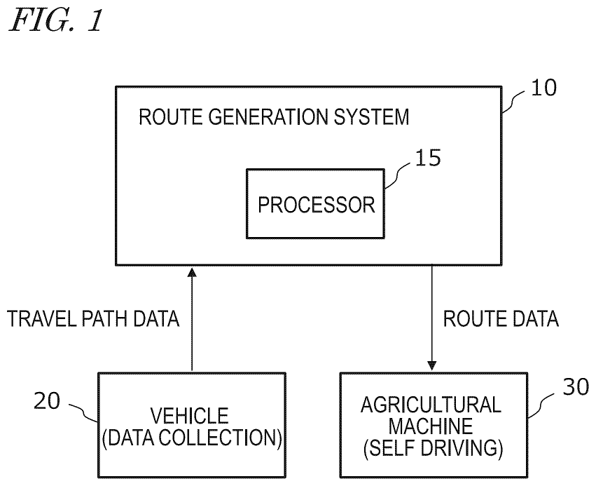

FIG. 1 is a block diagram showing an example of a route generation system for automated travel of agricultural machines. The route generation system 10 shown in FIG. 1 is used in combination with a vehicle 20 that collects data necessary for generating an automated travel route and an agricultural machine 30 that can travel automatically. The route generation system 10 is a computer system that includes a processor 15. The processor 15 is configured or programmed to generate an automated travel route for the agricultural machine 30 based on data collected by the vehicle 20. The vehicle 20 is a vehicle that collects data necessary for generating an automated travel route for the agricultural machine 30. The vehicle 20 can be, for example, a regular automobile, a truck (lorry), a van, or an agricultural work vehicle. The agricultural machine 30 is an automated driving agricultural machine travels automatically according to the automated travel route generated by the processor 15. The agricultural machine 30 is an agricultural work vehicle, such as a tractor. The agricultural machine 30 can automatically travel not only inside a field but also on roads outside the field (such as farm roads or public roads).

In the example shown in FIG. 1, the vehicle 20 is a different vehicle from the agricultural machine 30, but the agricultural machine 30 may function also as the vehicle 20. That is, a single agricultural work vehicle capable of both automated driving and manual driving may be used both as the agricultural machine 30 and as the vehicle 20. The route generation system 10 may be a system independent of the vehicle 20 and the agricultural machine 30 (e.g., a cloud computing system), or it may be mounted on the vehicle 20 or the agricultural machine 30. Here, an example will be described in which the vehicle 20 and the agricultural machine 30 are different vehicles, and the route generation system 10 is a system independent of the vehicle 20 and the agricultural machine 30.

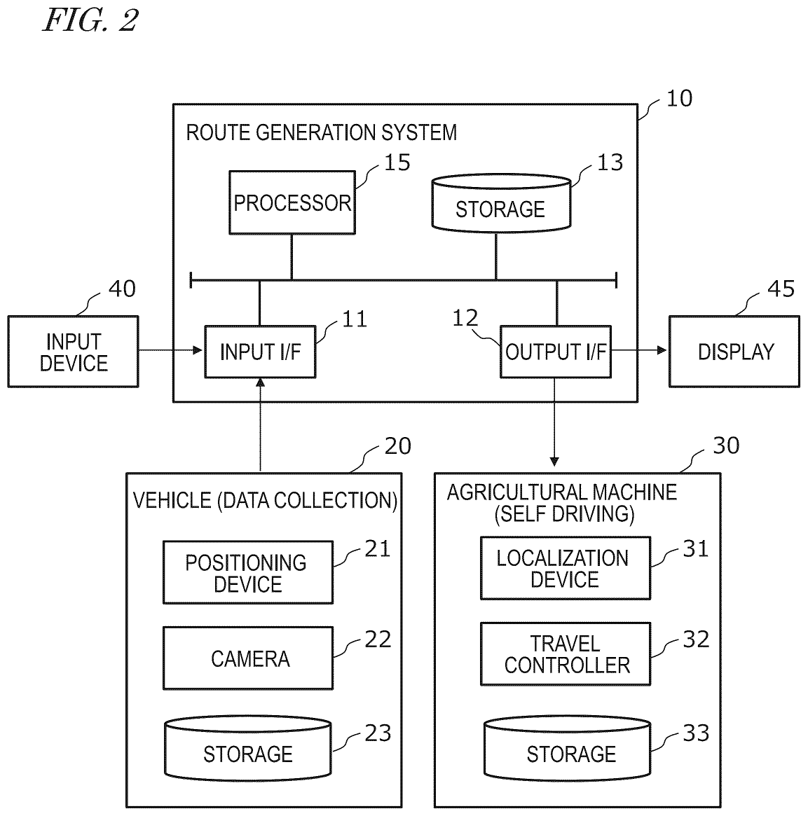

FIG. 2 is a block diagram showing an example of a more detailed configuration of the system shown in FIG. 1. In the example shown in FIG. 2, the route generation system 10 includes the processor 15, an input interface (I/F) 11, an output interface 12, and a storage 13. The vehicle 20 includes a positioning device 21, a camera 22, and a storage 23. The agricultural machine 30 includes a localization device 31, a travel controller 32, and a storage 33. FIG. 2 also shows a display 45 that displays the automated travel route generated by the processor 15 and an input device 40 that is used by the user to perform an operation of editing the automated travel route.

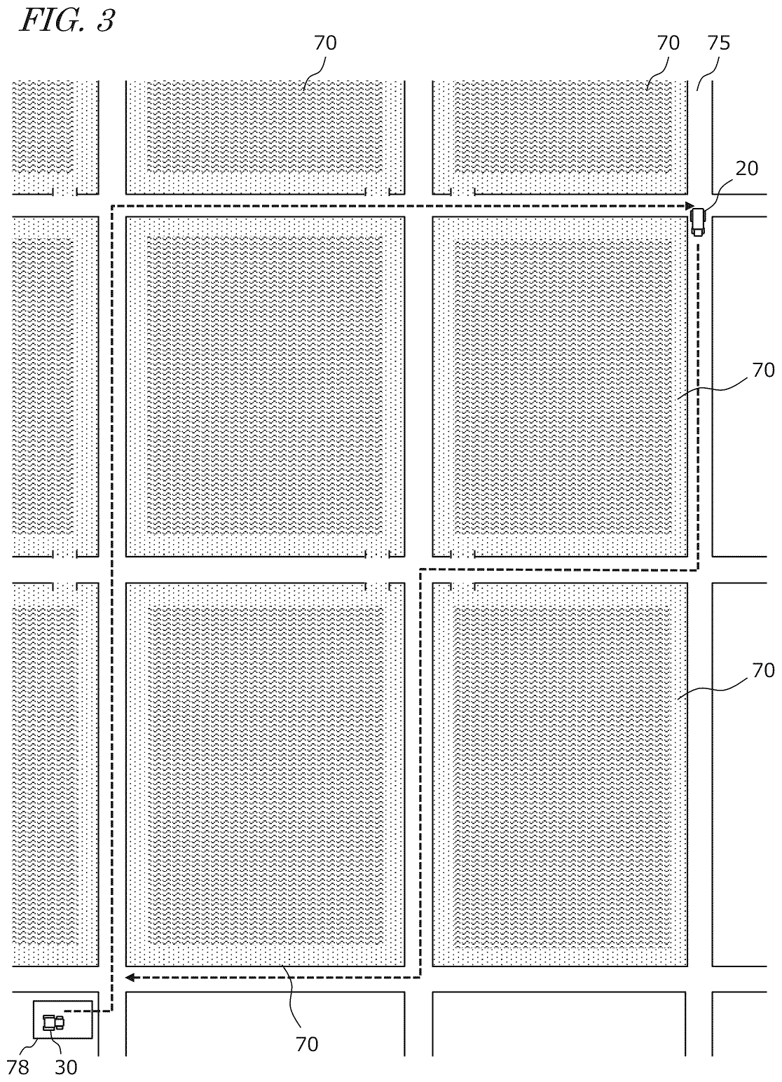

FIG. 3 is a diagram schematically showing the vehicle 20 traveling on a road 75 outside a field 70 (e.g., a farm road) while collecting data. FIG. 3 shows a plurality of fields 70, roads 75 around the fields 70, and a storage shed 78 for the agricultural machine 30. Before starting to operate the agricultural machine 30, the user drives the vehicle 20 along the route that the agricultural machine 30 is scheduled to travel automatically later. The vehicle 20 travels while recording its own travel path. For example, while traveling, the vehicle 20 records, in the storage 23, the position data sequentially output from the positioning device 21 such as a GNSS receiver as data that represents the travel path. The position data can include, for example, information on latitude and longitude in a geographic coordinate system. The data representing the travel path can include the position data of the vehicle 20 and corresponding time information. That is, the data representing the travel path can indicate the change over time of the position of the vehicle 20. The data representing the travel path may include information on the traveling speed of the vehicle 20 at each point in time, in addition to information on the position of the vehicle 20 at each point in time. The information on the position and traveling speed of the vehicle 20 can be recorded at relatively short time intervals (e.g., from several milliseconds to several seconds).

In FIG. 3, an example travel path of the vehicle 20 is shown by a dashed arrow. In the example of FIG. 3, the vehicle 20 travels from the storage shed 78 along a road 75 around the fields 70 where agricultural work by the agricultural machine 30 is scheduled, and returns to the storage shed 78. The route that vehicle 20 travels to collect data is determined according to the route that the agricultural machine 30 is scheduled to travel. The vehicle 20 travels, by manual driving, along the route that the agricultural machine 30 is scheduled to travel automatically while recording the travel path. In the present specification, the vehicle 20 traveling by manual driving by a driver will be expressed “travel manually”. The vehicle 20 may travel while imaging an area around the vehicle 20 with the camera 22. In that case, the vehicle 20 travels while recording the video image taken by the camera 22 in the storage 23.

After completion of the data collection by the vehicle 20, the data representing the travel path is sent to the processor 15. The data representing the travel path may be transmitted to the processor 15 via a wired or wireless communication line, or may be provided to the processor 15 via any recording medium. In either way, the processor 15 may be configured or programmed to acquire the data representing the travel path directly or indirectly from the vehicle 20. The processor 15 is configured or programmed to generate an automated travel route for the agricultural machine 30 based on the acquired data representing the travel path. For example, the processor 15 may be configured or programmed to approximate the travel path of the vehicle 20 as a combination of a plurality of line segments on a map prepared in advance, and generate the combination of those line segments as an automated travel route.

In the example shown in FIG. 3, there are no obstacles on the road 75 that the vehicle 20 travels, and the vehicle 20 travels in a straight line except when turning right or turning left. In such a case, an automated travel route can be appropriately generated by approximating the travel path of the vehicle 20 with a plurality of line segments. However, when the vehicle 20 is traveling, there may be an oncoming vehicle in front. In that case, if the road 75 is narrow in width, the vehicle 20 will take action to avoid the oncoming vehicle. For example, the vehicle 20 may perform an avoidance action of slowing down and moving to the edge of the road 75, or moving backwards or temporarily stopping to avoid contact with the oncoming vehicle. In such a case, the travel path associated with the avoidance action is also recorded, so if an automated travel route is simply generated based on the data representing the travel path, an inappropriate automated travel route reflecting the avoidance action will be generated.

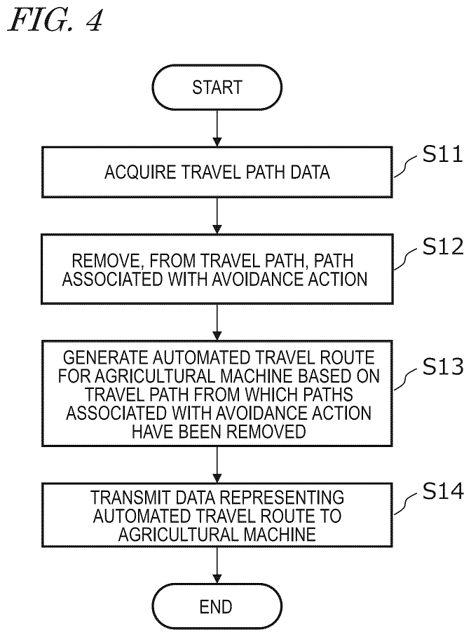

In order to solve the above problem, the processor 15 of the present example embodiment is configured or programmed to generate an automated travel route after removing paths associated with an avoidance action from the travel path of the vehicle 20. An example of this process will now be described with reference to FIG. 4.

FIG. 4 is a flow chart showing an example of an operation of generating an automated travel route by the processor 15. The processor 15 first acquires the travel path data recorded by the vehicle 20 (step S11). Next, the processor 15 removes paths associated with an avoidance action taken to avoid an oncoming vehicle from the travel path represented by the travel path data (step S12). An example of a method for identifying paths associated with an avoidance action from the travel path will be described later. The processor 15 generates an automated travel route for the agricultural machine 30 based on the travel path from which paths associated with an avoidance action have been removed (S13). For example, an automated travel route can be generated by performing a complementing process such as approximating any removed portion with a line segment. Then, the processor 15 transmits data representing the automated travel route to the agricultural machine 30 (step S14). Note that if the processor 15 is installed in the agricultural machine 30, the operation of step S14 may be omitted.

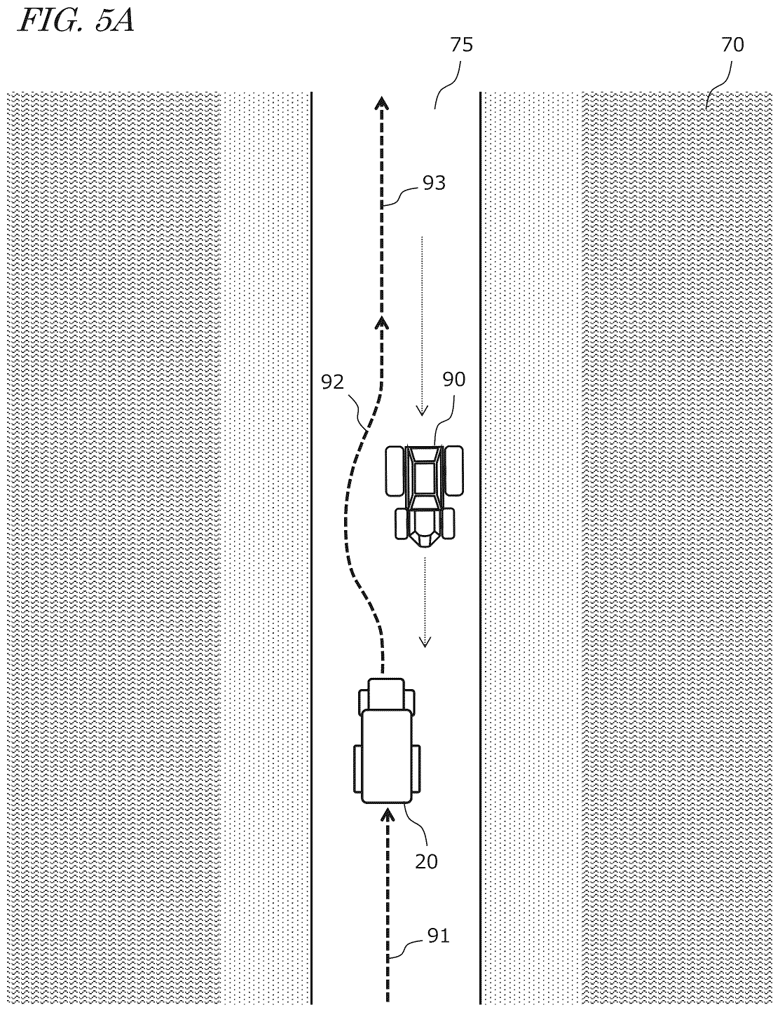

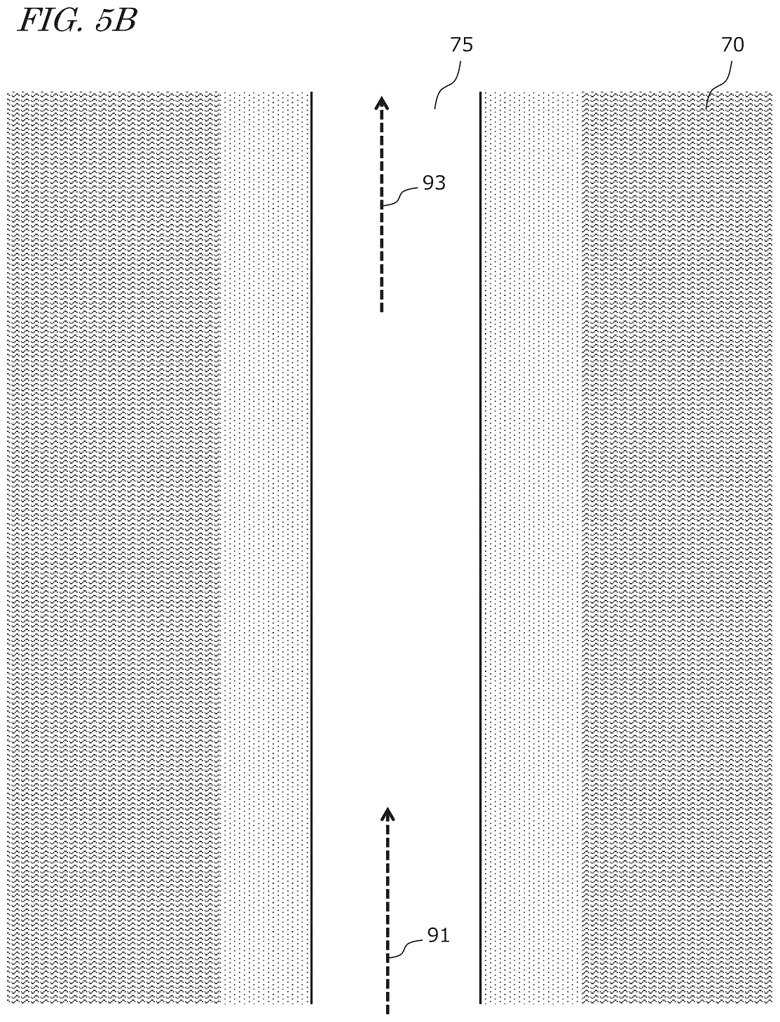

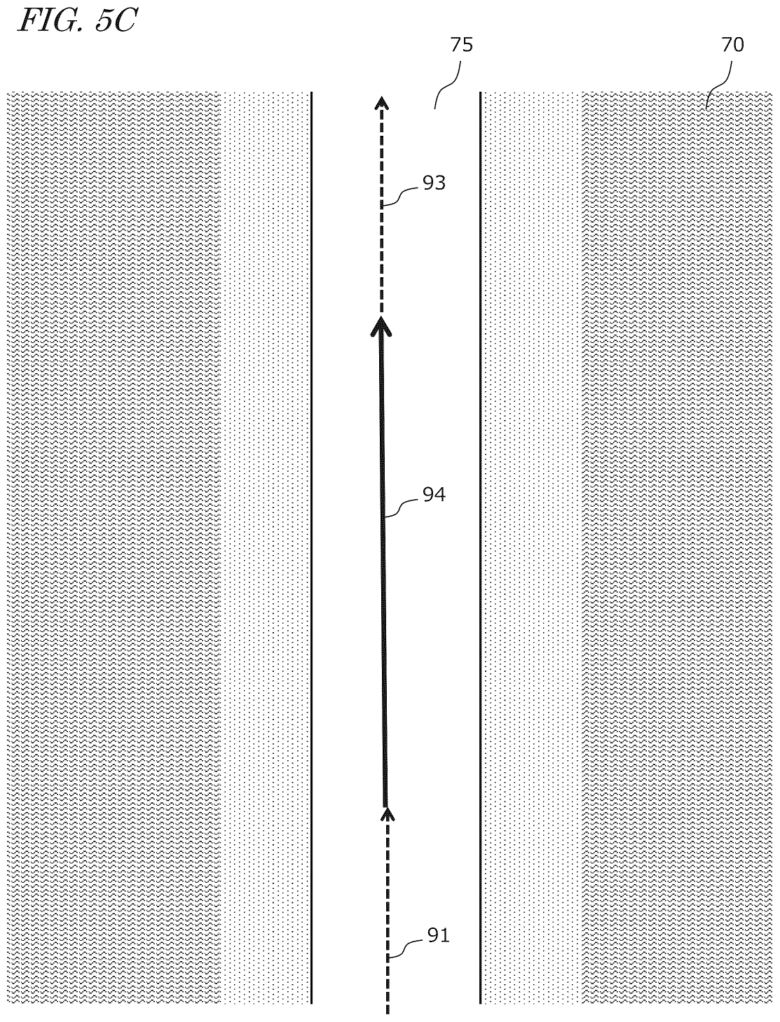

Now, referring to FIGS. 5A to 5C, a specific example of the operation of step S12 and step S13 will be described.

FIG. 5A shows an example of an operation in which the vehicle 20 avoids an oncoming vehicle 90. In this example, the driver of the vehicle 20 steers the vehicle 20 so that the vehicle 20 first pulls over to the left edge of the road 75 to avoid contact with the oncoming vehicle 90 coming from the front, and then the vehicle 20 returns near the center of the road 75 after passing by the oncoming vehicle 90. Therefore, the travel path recorded by the vehicle 20 will be two straight lines 91 and 93 and a non-straight route 92 due to the avoidance action connected to the as straight lines 91 and 93, as shown by dashed arrows in FIG. 5A.

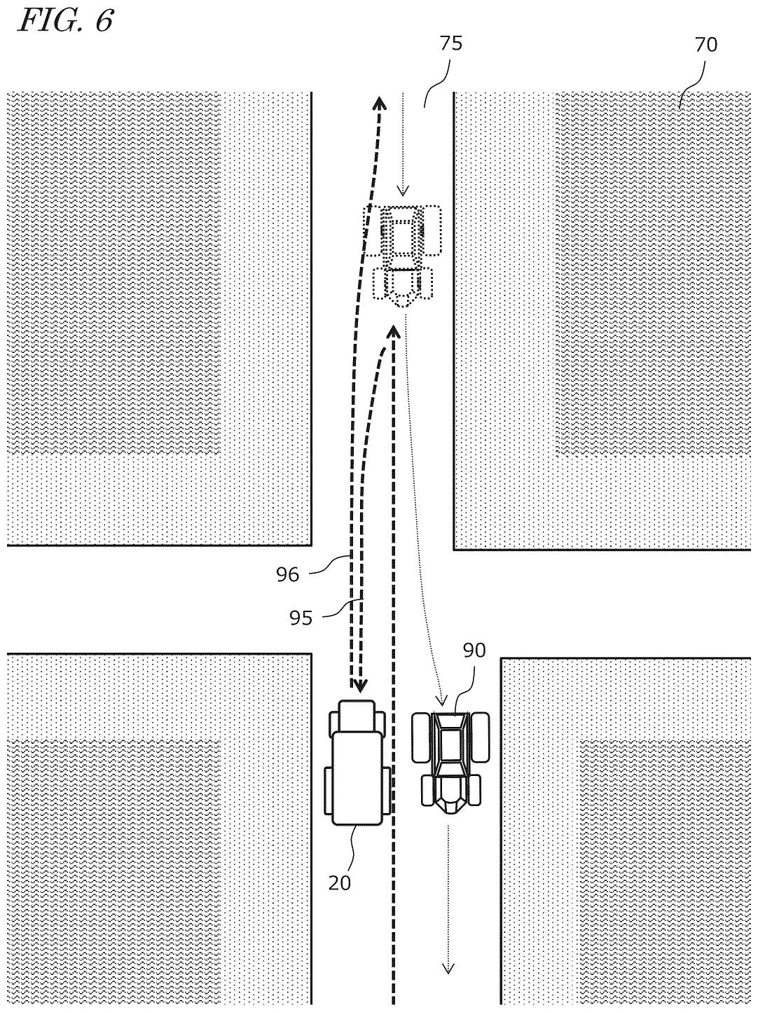

The route associated with the avoidance action (hereinafter referred to also as the “avoidance route”) is not limited to the route 92 shown in FIG. 5A. For example, as shown in FIG. 6, the avoidance route may include a backward route 95 and a forward route 96 thereafter. In the example of FIG. 6, the width of road 75 is narrow, and the vehicle 20 and the oncoming vehicle 90 cannot pass each other. In such a case, the vehicle 20 first travels backward to return to a location wide enough to pass each other, temporarily stops, and after the oncoming vehicle 90 has passed, travels forward to return to the original route.

When the processor 15 acquires data on the travel path of the vehicle 20, the processor 15 extracts and removes paths associated with the avoidance action from the travel path represented by the data. FIG. 5B shows an example of a travel path from which the path associated with the avoidance action has been removed.

The processor 15 may extract paths associated with the avoidance action based on the data of the video image taken by the camera 22 while the vehicle 20 is traveling. In that case, in step S11 shown in FIG. 4, the processor 15 acquires the data of the video image in addition to the data of the travel path. The processor 15 detects an avoidance action based on the video image, and determines and removes paths associated with the avoidance action from the travel path.

The processor 15 may perform an image recognition process based on the video image, and determine paths associated with the avoidance action based on the result of identifying the oncoming vehicle 90 approaching the vehicle 20 from the video image. For example, the processor 15 may remove, as paths associated with the avoidance action, paths corresponding to at least a portion of the period from when the oncoming vehicle 90 is identified in the video image to when the oncoming vehicle 90 is no longer identified, from the travel path. Alternatively, the processor 15 may remove, as paths associated with the avoidance action, paths corresponding to a predetermined length of time (e.g., 10 seconds, 20 seconds, or 30 seconds, etc.) in the travel path, which includes a period from when the oncoming vehicle 90 is identified to have approached the vehicle 20 to a predetermined distance (e.g., 5 m, 10 m, or 20 m, etc.) in the video image to when the oncoming vehicle 90 is no longer identified.

The processor 15 may detect an avoidance action based on the change over time of the position of the vehicle 20 indicated by the travel path. For example, the processor 15 may detect, as an avoidance action, at least one of traveling backward, changing the direction, accelerating, and decelerating done by the vehicle 20 to avoid the oncoming vehicle 90. As an example, the processor 15 may extract, as a path associated with an avoidance action, a portion of the travel path that traces a non-straight path, even though it is a path for a straight section of the road 75. Extracting paths associated with an avoidance action may be done using the record of steering and/or accelerating/decelerating operation of the vehicle 20. For example, the processor 15 may extract, as a path associated with an avoidance action, a portion of the travel path where a significant change of direction is made at a position other than in an intersection on the road 75. The processor 15 may extract, as a path associated with an avoidance action, a portion of the travel path where the vehicle 20 decelerates or stops, or moves backward and then forward again while traveling along the road 75. Machine learning algorithms such as deep learning may be used to detect an avoidance action. The processor 15 may extract a path associated with an avoidance action from the travel path based on data of the travel path acquired from the vehicle 20 and a pre-trained learned model.

The processor 15 generates an automated travel route by removing paths associated with an avoidance action and then performing the process of complementing the removed portions. For example, as shown in FIG. 5C, the processor 15 may generate an automated travel route by complementing a portion removed from the travel path with a straight complementing route 94. Such a complementing process may be performed automatically by the processor 15 or in response to an operation from the user. For example, the processor 15 may display, on the display 45, the travel path with a path associated with an avoidance action removed, and may complement the portion that has been removed from the travel path in response to an operation by the user to confirm a complementing route using the input device 40.

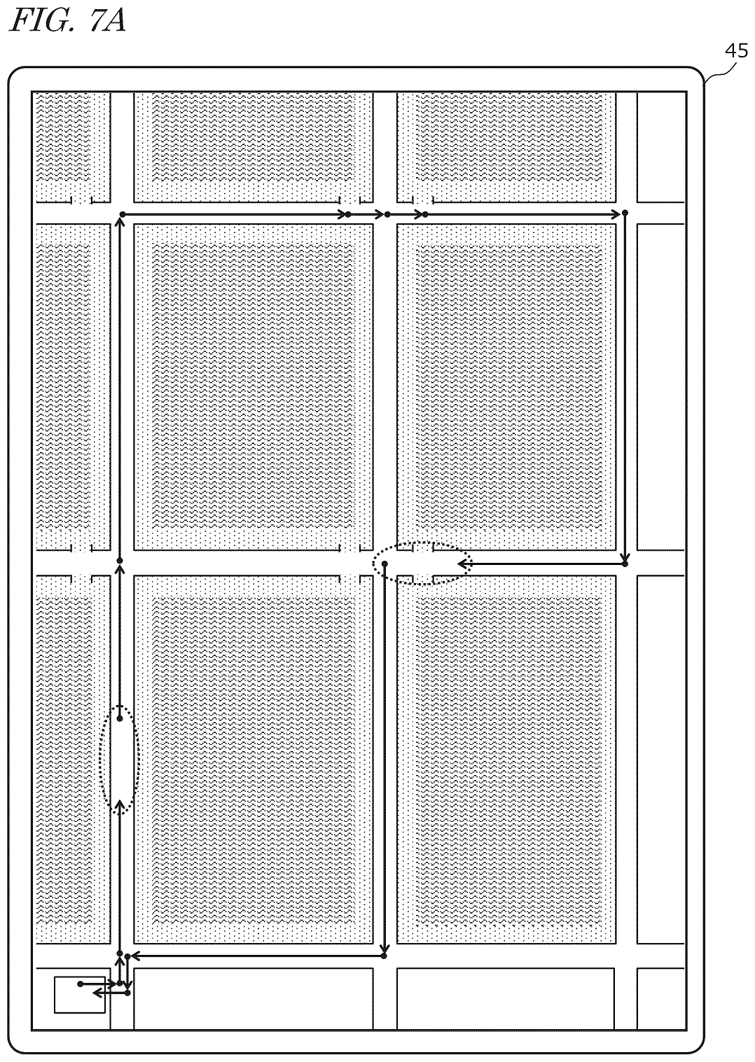

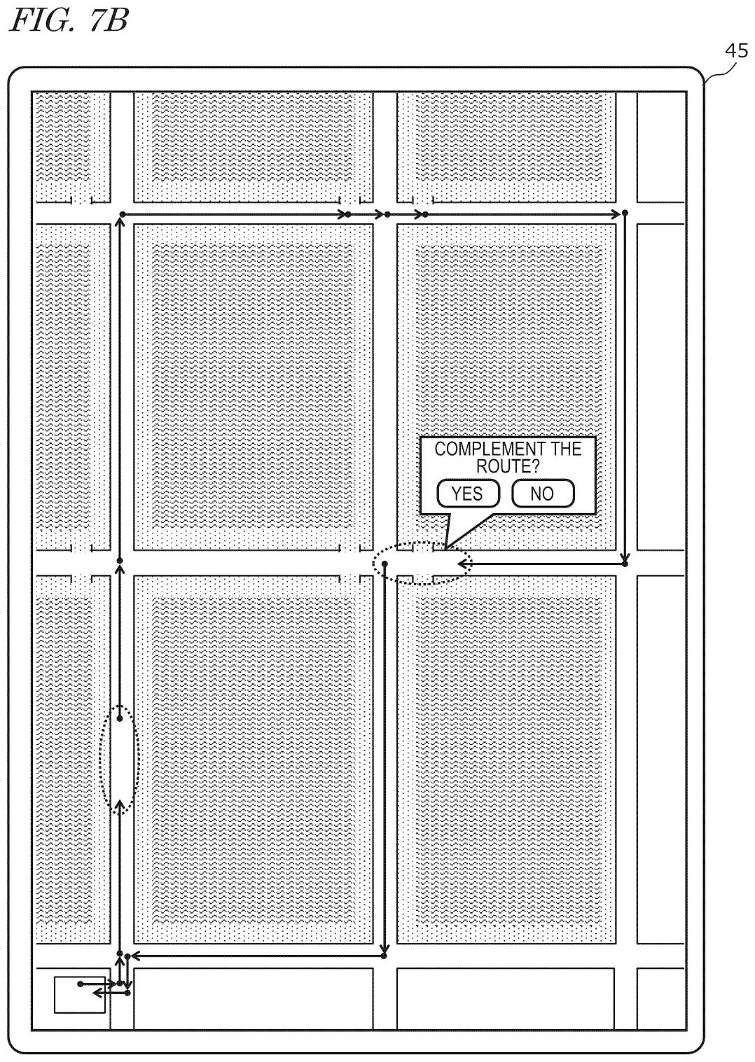

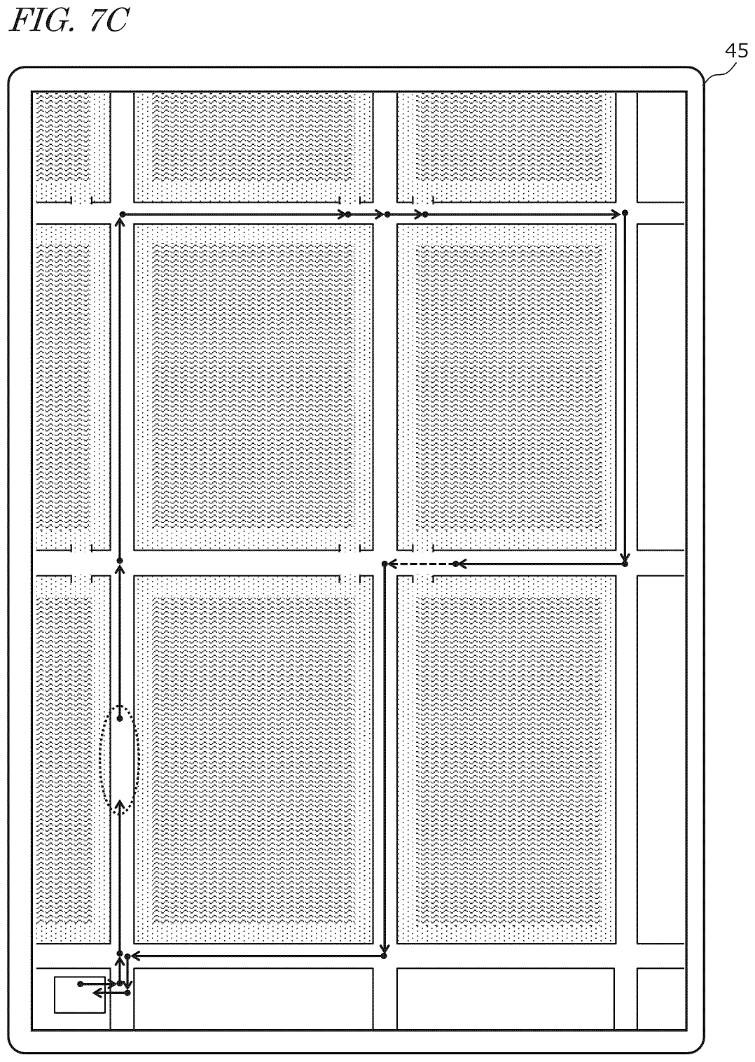

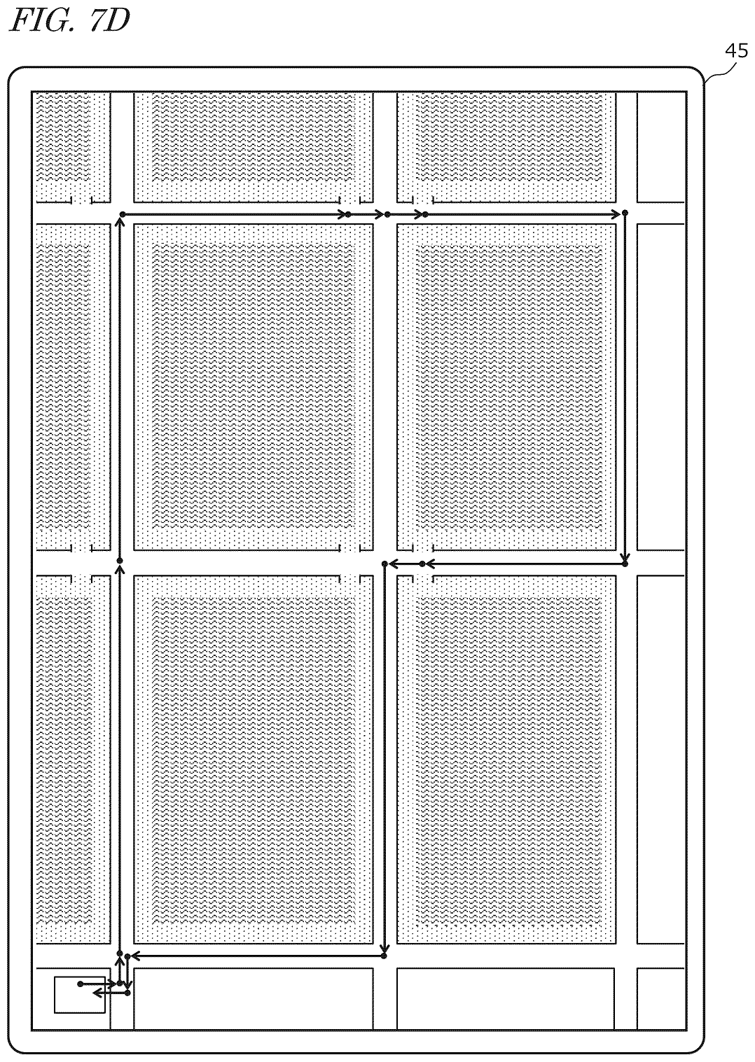

FIG. 7A is a diagram showing an example of a display on the display 45. The display 45 in this example is a computer with a built-in display, such as a tablet computer or a smartphone. The display 45 shown in the figure includes a touch screen and functions also as the input device 40. The display 45 displays an environment map around the fields 70. A route obtained by removing avoidance routes from the travel path of the vehicle 20 is shown on the map. In FIG. 7A, portions corresponding to the removed avoidance routes are encircled by dotted lines. The user can perform an operation of complementing the route by, for example, touching a dotted-line encircled portion.

FIG. 7B shows an example of the display screen when the user touches one of the dotted-line encircled portions. In this example, a pop-up window appears asking “Complement the route?”, and the user can select “Yes” or “No”. If the user selects “Yes”, the processor 15 generates a complementing route that complements the removed portion. The processor 15, for example, complements the removed portion with a straight complementing route. Alternatively, the user may be able to specify the complementing route.

FIG. 7C illustrates a state in which one of the removed portions has been complemented. The complemented portion is indicated by a dashed arrow. The user can similarly complement the other removed portion.

FIG. 7D illustrates a state in which all removed portions have been complemented to complete an automated travel route. The automated travel route can be defined by a plurality of waypoints, for example. Each waypoint can include information on position and speed, for example. In FIG. 7D, waypoints are represented by dots, and links between waypoints are represented by arrows. In this example, waypoints are set at locations where the agricultural machine 30 can change direction (such as at intersections, near the entrances and exits of fields, and near the entrance and exit of the storage shed). The method of setting waypoints is not limited to the illustrated example, and the length of the links between waypoints can be set arbitrarily.

The above operation prevents the avoidance action performed to avoid the oncoming vehicle 90 from being reflected in the automated travel route. Thus, it is possible to generate a more appropriate automated travel route for the agricultural machine 30.

The data representing the generated automated travel route is sent to the agricultural machine 30 and recorded in the storage 33. A travel controller 32 of the agricultural machine 30 is configured or programmed to control the traveling speed and steering of the agricultural machine 30 so that the agricultural machine 30 travels along the automated travel route. For example, if the automated travel route is defined by a plurality of waypoints, each of which includes position and speed information, the travel controller 32 is configured or programmed to control the traveling speed and steering so that the agricultural machine 30 passes through each waypoint at the specified speed. The travel controller 32 may be configured or programmed to estimate the extent to which the agricultural machine 30 deviates from the automated travel route based on the position and orientation of the agricultural machine 30 estimated by the localization device 31. The localization device 31 is a device that performs localization using sensors such as GNSS, IMU (Inertial Measurement Unit), LiDAR (Light Detection and Ranging), and/or cameras (including image sensors). The travel controller 32 can achieve traveling along the automated travel route by performing steering control to reduce the deviation of the position and/or orientation of the agricultural machine 30 from the automated travel route.

In the present example embodiment, the processor 15 executes the above-mentioned process when generating a route for the agricultural machine 30 to travel automatically outside the field. The processor 15 may also execute a similar process when generating a route for the agricultural machine 30 to travel automatically inside the field. Even inside the field, other agricultural work vehicles may be present as oncoming vehicles, and the route generation method of the present example embodiment is effective.

Next, an example embodiment in which at least one of the technologies of the present disclosure is applied to a work vehicle such as a tractor, which is an example of the agricultural machine will be described. The technologies of the present disclosure can be applied not only to work vehicles such as tractors, but also to other types of agricultural machines.

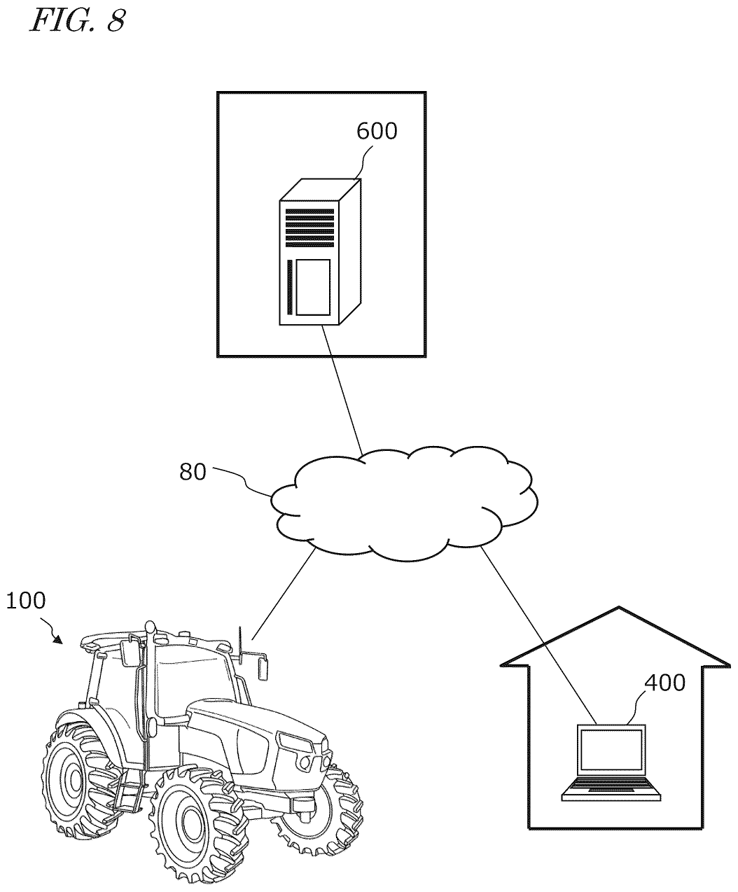

FIG. 8 is a diagram illustrating an overview of an agricultural management system in an example embodiment of the present disclosure. The system shown in FIG. 8 includes a work vehicle 100, a terminal device 400, and a management device 600. The work vehicle 100 is an agricultural machine capable of automated travel. The terminal device 400 is a computer used by a user who monitors the work vehicle 100 remotely. The management device 600 is a computer managed by an operator who operates the system. The work vehicle 100, the terminal device 400, and the management device 600 can communicate with each other via a network 80. While FIG. 8 illustrates one work vehicle 100, the system may include a plurality of work vehicles or other agricultural machines. In the present example embodiment, the work vehicle 100 serves the function as both the vehicle 20 and the agricultural machine 30 shown in FIG. 1. The management device 600 includes the function of the processor 15 shown in FIG. 1.

The work vehicle 100 according to the present example embodiment is a tractor. The work vehicle 100 can have an implement attached to its rear and/or its front. While performing agricultural work in accordance with a particular type of implement, the work vehicle 100 is able to travel inside a field. The work vehicle 100 may travel inside the field or outside the field with no implement being attached thereto.

The work vehicle 100 has an automated driving function. In other words, the work vehicle 100 can travel by the action of a controller, rather than manually. The controller according to the present example embodiment is provided inside the work vehicle 100, and is able to control both the speed and steering of the work vehicle 100. The work vehicle 100 can perform automated travel outside the field (e.g., on roads) as well as inside the field.

The work vehicle 100 includes a device usable for positioning or localization, such as a GNSS receiver or an LiDAR sensor. Based on the position of the work vehicle 100 and information on a target path, the controller of the work vehicle 100 causes the work vehicle 100 to automatically travel. In addition to controlling the travel of the work vehicle 100, the controller also controls the operation of the implement. As a result, while automatically traveling inside the field, the work vehicle 100 is able to perform agricultural work by using the implement. In addition, the work vehicle 100 is able to automatically travel along the target path on a road outside the field (e.g., an agricultural road or a general road). In the case of performing automated travel on a road outside the field, the work vehicle 100 travels while generating, along the target path, a local path along which the work vehicle 100 can avoid an obstacle, based on data output from a sensing device such as a camera or a LiDAR sensor. Inside the field, the work vehicle 100 may travel while generating a local path in substantially the same manner as described above, or may perform an operation of traveling along the target path without generating a local path and halting when an obstacle is detected.

The management device 600 is a computer to manage the agricultural work performed by the work vehicle 100. The management device 600 may be, for example, a server computer configured or programmed to perform centralized management on information regarding the field on the cloud and supports agriculture by use of the data on the cloud. The management device 600 includes functions equivalent to those of the processor 15 shown in FIG. 1. That is, the management device 600 generates an automated travel route (i.e., a target path) for the work vehicle 100. The management device 600 acquires data showing the travel path taken by the work vehicle 100 when driven manually, and generates an automated travel route for the work vehicle 100 based on this data. More specifically, before the work vehicle 100 starts automated travel, the work vehicle 100 manually travels the route the work vehicle 100 is scheduled to travel automatically while recording its path. The work vehicle 100 records the travel path by sequentially recording its own position using a positioning device such as a GNSS unit. After the traveling for data recording is completed, the management device 600 acquires data representing the travel path from the work vehicle 100. The travel path may include a path associated with an avoidance action taken to avoid an oncoming vehicle on a road. The management device 600 removes the path associated with an avoidance action taken to avoid an oncoming vehicle from the travel path represented by the data acquired by the method described above, and generates an automated travel route for the work vehicle 100 based on the travel path from which the path has been removed. By such a process, it is possible to generate an appropriate automated travel route without reflecting paths associated with avoidance actions.

The management device 600 may also create a work plan for the work vehicle 100 and, according to the work plan, give instructions to the work vehicle 100 to start and end automated travel. The management device 600 may also generate an environment map based on data collected by the work vehicle 100 or other vehicles using a sensing device such as a LiDAR sensor.

The management device 600 transmits the data, such as the generated automated travel route, work plan, and environment map, to the work vehicle 100. The work vehicle 100 automatically performs traveling and agricultural work based on those data.

Note that the automated travel route may be generated not only by the management device 600, but also by other devices. For example, the controller of the work vehicle 100 may be configured or programmed to generate the automated travel route. In that case, the controller of the work vehicle 100 functions as a processor configured or programmed to generate the automated travel route.

The terminal device 400 is a computer that is used by a user who is at a remote place from the work vehicle 100. The terminal device 400 shown in FIG. 8 is a laptop computer, but the terminal device 400 is not limited to this. The terminal device 400 may be a stationary computer such as a desktop PC (personal computer), or a mobile terminal such as a smartphone or a tablet computer. The terminal device 400 may be used to perform remote monitoring of the work vehicle 100 or remote-manipulate the work vehicle 100. For example, the terminal device 400 can display, on a display screen thereof, a video captured by one or more cameras (imagers) included in the work vehicle 100. The user can watch the video to check the state of the surroundings of the work vehicle 100 and instruct the work vehicle 100 to halt or begin traveling. The terminal device 400 may also include the functions of the input device 40 and display 45 shown in FIG. 2. That is, the terminal device 400 may be used to edit the automated travel route generated by the management device 600.

Hereinafter, a configuration and an operation of the system according to the present example embodiment will be described in more detail.

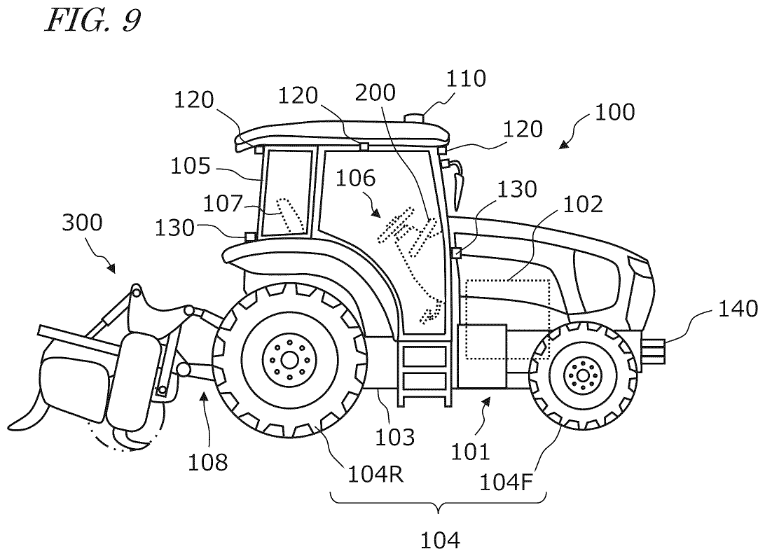

FIG. 9 is a side view schematically showing an example of the work vehicle 100 and an example of implement 300 linked to the work vehicle 100. The work vehicle 100 according to the present example embodiment can operate both in a manual driving mode and automated driving mode. In the automated driving mode, the work vehicle 100 is able to perform unmanned travel. The work vehicle 100 can perform automated driving both inside a field and outside the field.

As shown in FIG. 9, the work vehicle 100 includes a vehicle body 101, a prime mover (engine) 102, and a transmission 103. On the vehicle body 101, wheels 104 with tires and a cabin 105 are provided. The wheels 104 include a pair of front wheels 104F and a pair of rear wheels 104R. Inside the cabin 105, a driver's seat 107, a steering device 106, an operation terminal 200, and switches for manipulation are provided. One or both of the front wheel 104F and the rear wheel 104R may be replaced with a plurality of wheels to which a continuous track is attached (crawler) instead of a tire-mounted wheel.

The work vehicle 100 includes a plurality of sensing devices sensing the surroundings of the work vehicle 100. In the example shown in FIG. 9, the sensing devices include a plurality of cameras 120, a LiDAR sensor 140, and a plurality of obstacle sensors 130.

The cameras 120 may be provided at the front/rear/right/left of the work vehicle 100, for example. The cameras 120 image the surrounding environment of the work vehicle 100 and generate image data. The images acquired by the cameras 120 may be transmitted to the terminal device 400, which is responsible for remote monitoring. The images may be used to monitor the work vehicle 100 during unmanned driving. The cameras 120 may also be used to generate images to allow the work vehicle 100, traveling on a road outside the field (an agricultural road or a general road), to recognize objects, obstacles, white lines, road signs, traffic signs or the like in the surroundings of the work vehicle 100. For example, the cameras 120 may also be used to detect an oncoming vehicle when the work vehicle 100 is traveling by manual driving while recording the travel path.

The LiDAR sensor 140 in the example of FIG. 9 is disposed on a bottom portion of a front surface of the vehicle body 101. The LiDAR sensor 140 may be disposed at any other position. While the work vehicle 100 is traveling mainly outside the field, the LiDAR sensor 140 repeatedly outputs sensor data representing the distance and the direction between an object existing in the surrounding environment thereof and each of measurement points, or a two-dimensional or three-dimensional coordinate values of each of the measurement points. The sensor data output from the LiDAR sensor 140 is processed by the controller of the work vehicle 100. The controller may be configured or programmed to perform localization of the work vehicle 100 by matching the sensor data against the environment map. The controller may be configured or programmed to detect an object such as an obstacle existing in the surroundings of the work vehicle 100 based on the sensor data, and generate, along the target path, a local path along which the work vehicle 100 needs to actually proceed. The controller can be configured or programmed to utilize an algorithm such as, for example, SLAM (Simultaneous Localization and Mapping) to generate or edit an environment map. The work vehicle 100 may include a plurality of LiDAR sensors disposed at different positions with different orientations.

The plurality of obstacle sensors 130 shown in FIG. 9 are provided at the front and the rear of the cabin 105. The obstacle sensors 130 may be disposed at other positions. For example, one or more obstacle sensors 130 may be disposed at any position at the sides, the front or the rear of the vehicle body 101. The obstacle sensors 130 may include, for example, a laser scanner or an ultrasonic sonar. The obstacle sensors 130 may be used to detect obstacles in the surroundings of the work vehicle 100 during automated travel to cause the work vehicle 100 to halt or detour around the obstacles. The LiDAR sensor 140 may be used as one of the obstacle sensors 130.

The work vehicle 100 further includes a GNSS unit 110. The GNSS unit 110 includes a GNSS receiver. The GNSS receiver may include an antenna to receive a signal(s) from a GNSS satellite(s) and a processor to calculate the position of the work vehicle 100 based on the signal(s) received by the antenna. The GNSS unit 110 receives satellite signals transmitted from the plurality of GNSS satellites, and performs positioning based on the satellite signals. GNSS is the general term for satellite positioning systems such as GPS (Global Positioning System), QZSS (Quasi-Zenith Satellite System; e.g., MICHIBIKI), GLONASS, Galileo, and BeiDou. Although the GNSS unit 110 according to the present example embodiment is disposed above the cabin 105, it may be disposed at any other position.

The GNSS unit 110 may include an inertial measurement unit (IMU). Signals from the IMU can be used to complement position data. The IMU can measure a tilt or a small motion of the work vehicle 100. The data acquired by the IMU can be used to complement the position data based on the satellite signals, so as to improve the performance of positioning.

The controller of the work vehicle 100 may be configured or programmed to utilize, for positioning, the sensing data acquired by the sensing devices such as the cameras 120 or the LIDAR sensor 140, in addition to the positioning results provided by the GNSS unit 110. In the case where objects serving as characteristic points exist in the environment that is traveled by the work vehicle 100, as in the case of an agricultural road, a forest road, a general road or an orchard, the position and the orientation of the work vehicle 100 can be estimated with a high accuracy based on data that is acquired by the cameras 120 or the LiDAR sensor 140 and on an environment map that is previously stored in the storage. By correcting or complementing position data based on the satellite signals using the data acquired by the cameras 120 or the LiDAR sensor 140, it becomes possible to identify the position of the work vehicle 100 with a higher accuracy.

The prime mover 102 may be a diesel engine, for example. Instead of a diesel engine, an electric motor may be used. The transmission 103 can change the propulsion and the moving speed of the work vehicle 100 through a speed changing mechanism. The transmission 103 can also switch between forward travel and backward travel of the work vehicle 100.

The steering device 106 includes a steering wheel, a steering shaft connected to the steering wheel, and a power steering device to assist in the steering by the steering wheel. The front wheels 104F are the wheels responsible for steering, such that changing their angle of turn (also referred to as “steering angle”) can cause a change in the traveling direction of the work vehicle 100. The steering angle of the front wheels 104F can be changed by manipulating the steering wheel. The power steering device includes a hydraulic device or an electric motor to supply an assisting force to change the steering angle of the front wheels 104F. When automatic steering is performed, under the control of the controller disposed in the work vehicle 100, the steering angle may be automatically adjusted by the power of the hydraulic device or the electric motor.

A linkage device 108 is provided at the rear of the vehicle body 101. The linkage device 108 includes, e.g., a three-point linkage (also referred to as a “three-point link” or a “three-point hitch”), a PTO (Power Take Off) shaft, a universal joint, and a communication cable. The linkage device 108 allows the implement 300 to be attached to, or detached from, the work vehicle 100. The linkage device 108 is able to raise or lower the three-point link with a hydraulic device, for example, thus changing the position and/or attitude of the implement 300. Moreover, motive power can be sent from the work vehicle 100 to the implement 300 via the universal joint. While towing the implement 300, the work vehicle 100 allows the implement 300 to perform a predetermined task. The linkage device may be provided frontward of the vehicle body 101. In that case, the implement can be connected frontward of the work vehicle 100.

Although the implement 300 shown in FIG. 9 is a rotary tiller, the implement 300 is not limited to a rotary tiller. For example, any arbitrary implement such as a seeder, a spreader, a transplanter, a mower, a rake implement, a baler, a harvester, a sprayer, or a harrow, can be connected to the work vehicle 100 for use.

The work vehicle 100 shown in FIG. 9 can be driven by human driving. Alternatively, it may only support unmanned driving. In that case, component elements which are only required for human driving, e.g., the cabin 105, the steering device 106, and the driver's seat 107 do not need to be provided in the work vehicle 100. An unmanned work vehicle 100 can travel via autonomous driving, or by remote manipulation by a user. When a work vehicle 100 that does not have the human driving function is used, the data for the travel path for route generation is acquired by a human-driven vehicle other than the work vehicle 100.

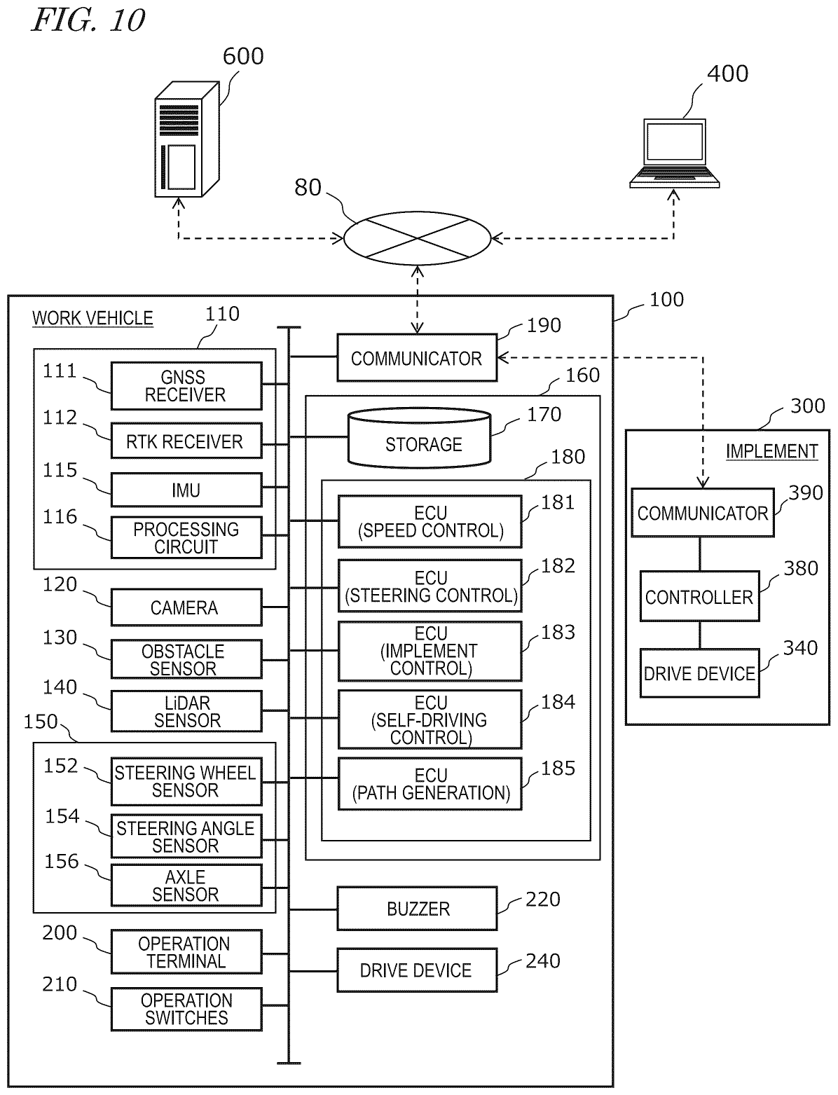

FIG. 10 is a block diagram showing an example configuration of the work vehicle 100 and the implement 300. The work vehicle 100 and the implement 300 can communicate with each other via a communication cable that is included in the linkage device 108. The work vehicle 100 is able to communicate with the terminal device 400 and the management device 600 via the network 80.

In addition to the GNSS unit 110, the cameras 120, the obstacle sensors 130, the LiDAR sensor 140 and the operation terminal 200, the work vehicle 100 in the example of FIG. 10 includes sensors 150 to detect the operating status of the work vehicle 100, a control system 160, a communicator 190, operation switches 210, a buzzer 220, and a drive device 240. These component elements are communicably connected to each other via a bus. The GNSS unit 110 includes a GNSS receiver 111, an RTK receiver 112, an inertial measurement unit (IMU) 115, and a processing circuit 116. The sensors 150 include a steering wheel sensor 152, an steering angle sensor 154, and a wheel axis sensor 156. The control system 160 includes a storage 170 and a controller 180. The controller 180 may be configured or programmed to include a plurality of electronic control units (ECU) 181 to 185. The implement 300 includes a drive device 340, a controller 380, and a communicator 390. Note that FIG. 10 shows component elements which are relatively closely related to the operations of automated driving by the work vehicle 100, while other components are omitted from illustration.

The GNSS receiver 111 in the GNSS unit 110 receives transmitted from the plurality of GNSS satellite signals satellites and generates GNSS data based on the satellite signals. The GNSS data is generated in a predetermined format such as, for example, the NMEA-0183 format. The GNSS data may include, for example, the identification number, the angle of elevation, the angle of direction, and a value representing the reception strength of each of the satellites from which the satellite signals are received.

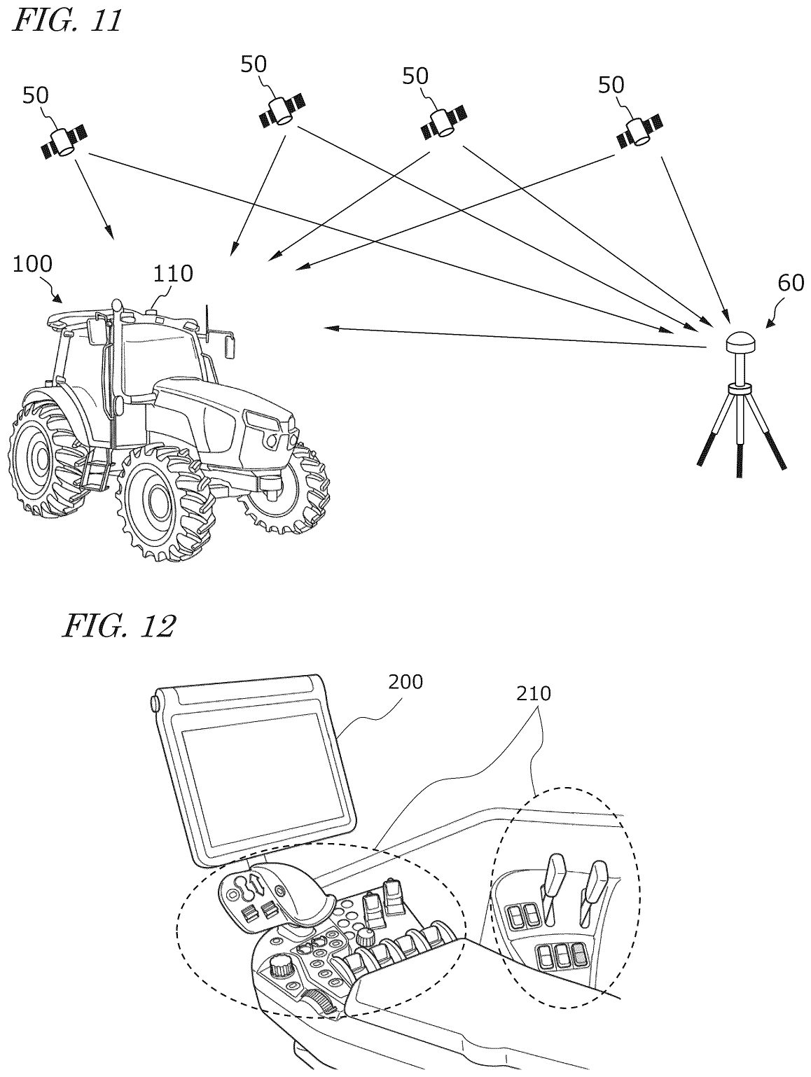

The GNSS unit 110 shown in FIG. 10 performs positioning of the work vehicle 100 by utilizing an RTK (Real Time Kinematic)-GNSS. FIG. 11 is a conceptual diagram showing an example of the work vehicle 100 performing positioning based on the RTK-GNSS. In the positioning based on the RTK-GNSS, not only satellite signals transmitted from a plurality of GNSS satellites 50, but also a correction signal that is transmitted from a reference station 60 is used. The reference station 60 may be disposed near the field where the work vehicle 100 performs tasked travel (e.g., at a position within 10 km of the work vehicle 100). The reference station 60 generates a correction signal of, for example, an RTCM format based on the satellite signals received from the plurality of GNSS satellites 50, and transmits the correction signal to the GNSS unit 110. The RTK receiver 112, which includes an antenna and a modem, receives the correction signal transmitted from the reference station 60. Based on the correction signal, the processing circuit 116 of the GNSS unit 110 corrects the results of the positioning performed by use of the GNSS receiver 111. Use of the RTK-GNSS enables positioning with an accuracy on the order of several centimeters of errors, for example. Positional information including latitude, longitude, and altitude information is acquired through the highly accurate positioning by the RTK-GNSS. The GNSS unit 110 calculates the position of the work vehicle 100 as frequently as, for example, one to ten times per second.

Note that the positioning method is not limited to being performed by use of an RTK-GNSS, and any arbitrary positioning method (e.g., an interferometric positioning method or a relative positioning method) that provides positional information with the necessary accuracy can be used. For example, positioning may be performed by utilizing a VRS (Virtual Reference Station) or a DGPS (Differential Global Positioning System). In the case where positional information with the necessary accuracy can be obtained without the use of the correction signal transmitted from the reference station 60, positional information may be generated without using the correction signal. In that case, the GNSS unit 110 does not need to include the RTK receiver 112.

Even in the case where the RTK-GNSS is used, at a site where the correction signal from the reference station 60 cannot be acquired (e.g., on a road far from the field), the position of the work vehicle 100 is estimated by another method with no use of the signal from the RTK receiver 112. For example, the position of the work vehicle 100 may be estimated by matching the data output from the LiDAR sensor 140 and/or the cameras 120 against a highly accurate environment map.

The GNSS unit 110 according to the present example embodiment further includes the IMU 115. The IMU 115 may include a 3-axis accelerometer and a 3-axis gyroscope. The IMU 115 may include a direction sensor such as a 3-axis geomagnetic sensor. The IMU 115 functions as a motion sensor which can output signals representing parameters such as acceleration, velocity, displacement, and attitude of the work vehicle 100. Based not only on the satellite signals and the correction signal but also on a signal that is output from the IMU 115, the processing circuit 116 can estimate the position and orientation of the work vehicle 100 with a higher accuracy. The signal that is output from the IMU 115 may be used for the correction or complementation of the position that is calculated based on the satellite signals and the correction signal. The IMU 115 outputs a signal more frequently than the GNSS receiver 111. Utilizing this signal that is output highly frequently, the processing circuit 116 allows the position and orientation of the work vehicle 100 to be measured more frequently (e.g., about 10 Hz or above). Instead of the IMU 115, a 3-axis accelerometer and a 3-axis gyroscope may be separately provided. The IMU 115 may be provided as a separate device from the GNSS unit 110.

The cameras 120 are imagers that image the surrounding environment of the work vehicle 100. Each of the cameras 120 includes an image sensor such as a CCD (Charge Coupled Device) or a CMOS (Complementary Metal Oxide Semiconductor), for example. In addition, each camera 120 may include an optical system including one or more lenses and a signal processing circuit. During travel of the work vehicle 100, the cameras 120 image the surrounding environment of the work vehicle 100, and generate image data (e.g., motion picture data). The cameras 120 are able to capture motion pictures at a frame rate of 3 frames/second (fps: frames per second) or greater, for example. The images generated by the cameras 120 may be used by a person monitoring remotely to check the surrounding environment of the work vehicle 100 with the terminal device 400, for example. The images generated by the cameras 120 may also be used for the purpose of positioning and/or detection of obstacles. For example, the images generated by the camera 120 when the work vehicle 100 is traveling to collect data of the travel path described above may be used in the process of detecting the action of recognizing oncoming vehicles and avoiding oncoming vehicles. As shown in FIG. 9, the plurality of cameras 120 may be provided at different positions on the work vehicle 100, or a single camera 120 may be provided. A visible light camera(s) to generate visible light images and an infrared camera(s) to generate infrared images may be separately provided. Both of a visible light camera(s) and an infrared camera(s) may be provided as cameras for generating images for monitoring purposes. The infrared camera(s) may also be used for detection of obstacles at nighttime.

The obstacle sensors 130 detect objects existing in the surroundings of the work vehicle 100. Each of the obstacle sensors 130 may include a laser scanner or an ultrasonic sonar, for example. When an object exists at a position within a predetermined distance from one of the obstacle sensors 130, the obstacle sensor 130 outputs a signal indicating the presence of the obstacle. The plurality of obstacle sensors 130 may be provided at different positions on the work vehicle 100. For example, a plurality of laser scanners and a plurality of ultrasonic sonars may be disposed at different positions on the work vehicle 100. Providing such a great number of obstacle sensors 130 can reduce blind spots in monitoring obstacles in the surroundings of the work vehicle 100.

The steering wheel sensor 152 measures the angle of rotation of the steering wheel of the work vehicle 100. The steering angle sensor 154 measures the angle of turn of the front wheels 104F, which are the wheels responsible for steering. Measurement values by the steering wheel sensor 152 and the steering angle sensor 154 are used for steering control by the controller 180.

The wheel axis sensor 156 measures the rotational speed, i.e., the number of revolutions per unit time, of a wheel axis that is connected to the wheels 104. The wheel axis sensor 156 may be a sensor including a magnetoresistive element (MR), a Hall generator, or an electromagnetic pickup, for example. The wheel axis sensor 156 outputs a numerical value indicating the number of revolutions per minute (unit: rpm) of the wheel axis, for example. The wheel axis sensor 156 is used to measure the speed of the work vehicle 100.

The drive device 240 includes various types of devices required to cause the work vehicle 100 to travel and to drive the implement 300, for example, the prime mover 102, the transmission 103, the steering device 106, the linkage device 108 and the like described above. The prime mover 102 may include an internal combustion engine such as, for example, a diesel engine. The drive device 240 may include an electric motor for traction instead of, or in addition to, the internal combustion engine.

The buzzer 220 is an audio output device to present an alarm sound to alert the user of an abnormality. For example, the buzzer 220 may present an alarm sound when an obstacle is detected during automated driving. The buzzer 220 is controlled by the controller 180.

The storage 170 includes one or more storage mediums such as a flash memory or a magnetic disc. The storage 170 stores various data that is generated by the GNSS unit 110, the cameras 120, the obstacle sensors 130, the LiDAR sensor 140, the sensors 150, and the controller 180. The data that is stored by the storage 170 may include map data on the environment where the work vehicle 100 travels (environment map) and data on an automated travel path (target path) for automated driving. The environment map includes information on a plurality of fields where the work vehicle 100 performs agricultural work and roads around the fields. The environment map and the target path may be generated by a processor in the management device 600. The controller 180 according to the present example embodiment is configured or programmed to generate or edit an environment map and a target path. The controller 180 can edit the environment map and the target path, acquired from the management device 160, in accordance with the environment where the work vehicle 100 travels. The storage 170 also stores a computer program(s) to cause each of the ECUs in the controller 180 to perform various operations described below. Such a computer program(s) may be provided to the work vehicle 100 via a storage medium (e.g., a semiconductor memory, an optical disc, etc.) or through telecommunication lines (e.g., the Internet). Such a computer program(s) may be marketed as commercial software.

The controller 180 is configured or programmed to include the plurality of ECUs. The plurality of ECUs include, for example, the ECU 181 for speed control, the ECU 182 for steering control, the ECU 183 for implement control, the ECU 184 for automated driving control, and the ECU 185 for path generation.

The ECU 181 controls the prime mover 102, the transmission 103 and brakes included in the drive device 240, thus controlling the speed of the work vehicle 100.

The ECU 182 controls the hydraulic device or the electric motor included in the steering device 106 based on a measurement value of the steering wheel sensor 152, thus controlling the steering of the work vehicle 100.

In order to cause the implement 300 to perform a desired operation, the ECU 183 controls the operations of the three-point link, the PTO shaft and the like that are included in the linkage device 108. Also, the ECU 183 generates a signal to control the operation of the implement 300, and transmits this signal from the communicator 190 to the implement 300.

Based on data output from the GNSS unit 110, the cameras 120, the obstacle sensors 130, the LiDAR sensor 140 and the sensors 150, the ECU 184 performs computation and control for achieving automated driving. For example, the ECU 184 specifies the position of the work vehicle 100 based on the data output from at least one of the GNSS unit 110, the cameras 120 and the LiDAR sensor 140. Inside the field, the ECU 184 may determine the position of the work vehicle 100 based only on the data output from the GNSS unit 110. The ECU 184 may estimate or correct the position of the work vehicle 100 based on the data acquired by the cameras 120 or the LiDAR sensor 140. Use of the data acquired by the cameras 120 or the LiDAR sensor 140 allows the accuracy of the positioning to be further improved. Outside the field, the ECU 184 estimates the position of the work vehicle 100 by use of the data output from the LiDAR sensor 140 or the cameras 120. For example, the ECU 184 may estimate the position of the work vehicle 100 by matching the data output from the LiDAR sensor 140 or the cameras 120 against the environment map. During automated driving, the ECU 184 performs computation necessary for the work vehicle 100 to travel along a target path or a local path, based on the estimated position of the work vehicle 100. The ECU 184 sends the ECU 181 a command to change the speed, and sends the ECU 182 a command to change the steering angle. In response to the command to change the speed, the ECU 181 controls the prime mover 102, the transmission 103 or the brakes to change the speed of the work vehicle 100. In response to the command to change the steering angle, the ECU 182 controls the steering device 106 to change the steering angle.

While the work vehicle 100 is traveling along the target path, the ECU 185 consecutively generates a local path along which the work vehicle 100 can avoid an obstacle. During travel of the work vehicle 100, the ECU 185 recognizes an obstacle existing in the surroundings of the work vehicle 100 based on the data output from the cameras 120, the obstacle sensors 130 and the LiDAR sensor 140. The ECU 185 generates a local path such that the work vehicle 100 avoids the recognized obstacle. The ECU 185 may have a function of generating a target path instead of the management device 160. In that case, the ECU 185 generates the target path based on data output from the GNSS unit 110, the camera 120, and/or the LiDAR sensor 140 while the work vehicle 100 is traveling to collect data. Examples of methods for generating the target path are as described referring to FIG. 3 to FIG. 7D. Note that the target path may be generated not only by the management device 600 or the ECU 185, but also by other devices such as the operation terminal 200 or the terminal device 400, for example.

Through the actions of these ECUs, the controller 180 realizes automated driving. During automated driving, the controller 180 is configured or programmed to control the drive device 240 based on the measured or estimated position of the work vehicle 100 and on the target path. As a result, the controller 180 can cause the work vehicle 100 to travel along the target path.

The plurality of ECUs included in the controller 180 can communicate with each other in accordance with a vehicle bus standard such as, for example, a CAN (Controller Area Network). Instead of the CAN, faster communication methods such as Automotive Ethernet (registered trademark) may be used. Although the ECUs 181 to 185 are illustrated as individual blocks in FIG. 10, the function of each of the ECU 181 to 185 may be implemented by a plurality of ECUS. Alternatively, an onboard computer that integrates the functions of at least some of the ECUs 181 to 185 may be provided. The controller 180 may include ECUs other than the ECUs 181 to 185, and any number of ECUs may be provided in accordance with functionality. Each ECU may include a processing circuit including one or more processors.

The communicator 190 is a device including a circuit communicating with the implement 300, the terminal device 400 and the management device 600. The communicator 190 includes circuitry to perform exchanges of signals complying with an ISOBUS standard such as ISOBUS-TIM, for example, between itself and the communicator 390 of the implement 300. This allows the implement 300 to perform a desired operation, or allows information to be acquired from the implement 300. The communicator 190 may further include an antenna and a communication circuit to exchange signals via the network 80 with communicators of the terminal device 400 and the management device 600. The network 80 may include a 3G, 4G, 5G, or any other cellular mobile communications network and the Internet, for example. The communicator 190 may have a function of communicating with a mobile terminal that is used by a supervisor who is situated near the work vehicle 100. With such a mobile terminal, communication may be performed based on any arbitrary wireless communication standard, e.g., Wi-Fi (registered trademark), 3G, 4G, 5G or any other cellular mobile communication standard, or Bluetooth (registered trademark).

The operation terminal 200 is a terminal for the user to perform a manipulation related to the travel of the work vehicle 100 and the operation of the implement 300, and is also referred to as a virtual terminal (VT). The operation terminal 200 may include a display such as a touch screen panel, and/or one or more buttons. The display may be a display such as a liquid crystal display or an organic light-emitting diode (OLED) display, for example. By manipulating the operation terminal 200, the user can perform various manipulations, such as, for example, switching ON/OFF the automated driving mode, recording or editing an environment map, setting a target path, and switching ON/OFF the implement 300. At least a portion of these manipulations may also be realized by manipulating the operation switches 210. The operation terminal 200 may be configured so as to be detachable from the work vehicle 100. A user who is at a remote place from the work vehicle 100 may manipulate the detached operation terminal 200 to control the operation of the work vehicle 100. Instead of the operation terminal 200, the user may manipulate a computer on which necessary application software is installed, for example, the terminal device 400, to control the operation of the work vehicle 100.

FIG. 12 is a diagram showing an example of the operation terminal 200 and an example of the operation switches 210 both provided in the cabin 105. In the cabin 105, the switches 210, including a plurality of switches that are manipulable to the user, are disposed. The operation switches 210 may include, for example, a switch to select the gear shift as to a main gear shift or a range gear shift, a switch to switch between automated driving mode and a manual driving mode, a switch to switch between forward travel and backward travel, a switch to raise or lower the implement 300, and the like. In the case where the work vehicle 100 only performs unmanned driving and lacks human driving functionality, the work vehicle 100 does not need to include the operation switches 210.

The drive device 340 in the implement 300 shown in FIG. 10 performs operations necessary for the implement 300 to perform predetermined work. The drive device 340 includes a device suitable for uses of the implement 300, for example, a hydraulic device, an electric motor, a pump or the like. The controller 380 controls the operation of the drive device 340. In response to a signal that is transmitted from the work vehicle 100 via the communicator 390, the controller 380 causes the drive device 340 to perform various operations. Moreover, a signal that is in accordance with the state of the implement 300 can be transmitted from the communicator 390 to the work vehicle 100.

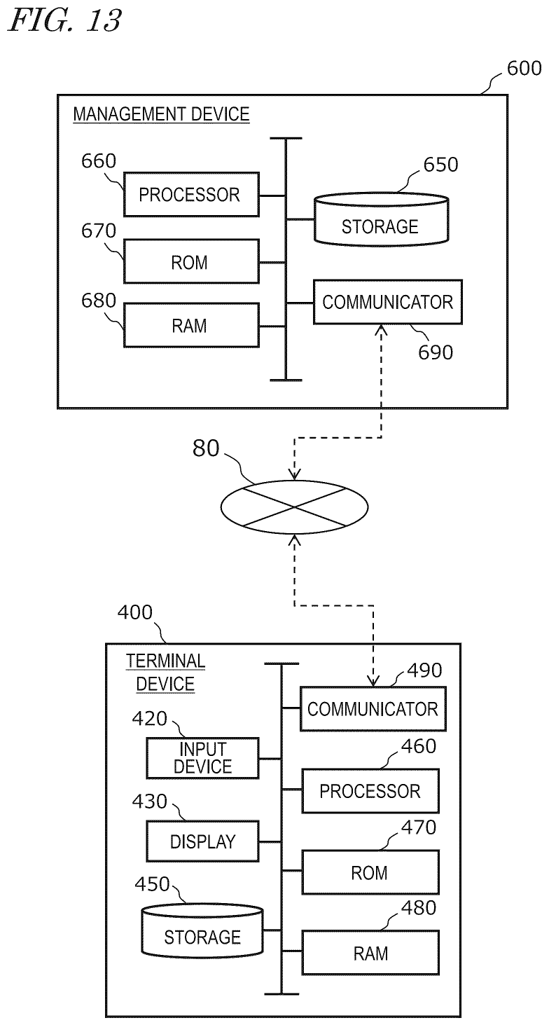

Now, a configuration of the management device 600 and the terminal device 400 will be described with reference to FIG. 13. FIG. 13 is a block diagram showing an example of schematic hardware configuration of the management device 600 and the terminal device 400.

The management device 600 includes a storage 650, a processor 660, a ROM (Read Only Memory) 670, a RAM (Random Access Memory) 680, and a communicator 690. These component elements are communicably connected to each other via a bus. The management device 600 may function as a cloud server to manage the schedule of the agricultural work to be performed by the work vehicle 100 in a field and support agriculture by use of the data managed by the management device 600 itself. The user can input information necessary to create a work plan by use of the terminal device 400 and upload the information to the management device 600 via the network 80. The management device 600 can create a schedule of agricultural work, that is, a work plan based on the information. The management device 600 can further generate or edit an environment map and generate an automated travel route for the work vehicle 100. The environment map may be distributed from a computer external to the management device 600.

The communicator 690 is a communication module to communicate with the work vehicle 100 and the terminal device 400 via the network 80. The communicator 690 can perform wired communication in compliance with communication standards such as, for example, IEEE1394 trademark) (registered or Ethernet (registered trademark). The communicator 690 may perform wireless communication in compliance with Bluetooth (registered trademark) or Wi-Fi, or cellular mobile communication based on 3G, 4G, 5G or any other cellular mobile communication standard.

The processor 660 may be, for example, a semiconductor integrated circuit including a central processing unit (CPU). The processor 660 may be realized by a microprocessor or a microcontroller. Alternatively, the processor 660 may be realized by an FPGA (Field Programmable Gate Array), a GPU (Graphics Processing Unit), an (Application Specific Integrated ASIC Circuit) or an ASSP (Application Specific Standard Product) each including a CPU, or a combination of two or more selected from these circuits. The processor 660 may be configured or programmed to consecutively execute a computer program, describing commands to execute at least one process, stored in the ROM 670 and thus realizes a desired process.

The ROM 670 is, for example, a writable memory (e.g., PROM), a rewritable memory (e.g., flash memory) or a memory which can only be read from but cannot be written to. The ROM 670 stores a program to control operations of the processor 660. The ROM 670 does not need to be a single storage medium, and may be an assembly of a plurality of storage mediums. A portion of the assembly of the plurality of storage memories may be a detachable memory.

The RAM 680 provides a work area in which the control program stored in the ROM 670 is once developed at the time of boot. The RAM 680 does not need to be a single storage medium, and may be an assembly of a plurality of storage mediums.

The storage 650 mainly functions as a storage for a database. The storage 650 may be, for example, a magnetic storage or a semiconductor storage. An example of the magnetic storage is a hard disc drive (HDD). An example of the semiconductor storage is a solid state drive (SSD). The storage 650 may be a device independent from the management device 600. For example, the storage 650 may be a storage connected to the management device 600 via the network 80, for example, a cloud storage.

The terminal device 400 includes an input device 420, a display 430, a storage 450, a processor 460, a ROM 470, a RAM 480, and a communicator 490. These component elements are communicably connected to each other via a bus. The input device 420 is a device to convert an instruction from the user into data and input the data to a computer. The input device 420 may be, for example, a keyboard, a mouse or a touch panel. The display 430 may be, for example, a liquid crystal display or an organic EL display. The processor 460, the ROM 470, the RAM 480, the storage 450 and the communicator 490 are substantially the same as the corresponding component elements described above regarding the example of the hardware configuration of the management device 600, and will not be described in repetition.

Next, an example operation of automated travel of the work vehicle 100 will be described. The work vehicle 100 according to the present example embodiment can automatically travel both inside and outside a field. Inside the field, the work vehicle 100 drives the implement 300 to perform predetermined agricultural work while traveling along a preset target path. When detecting an obstacle by the obstacle sensors 130 thereof while traveling inside the field, the work vehicle 100 halts traveling and performs operations of presenting an alarm sound from the buzzer 220, transmitting an alert signal to the terminal device 400 and the like. Inside the field, the positioning of the work vehicle 100 is performed based mainly on data output from the GNSS unit 110. Meanwhile, outside the field, the work vehicle 100 automatically travels along a target path set for an agricultural road or a general road outside the field. While traveling outside the field, the work vehicle 100 travels while detecting obstacles based on data acquired by the cameras 120 or the LiDAR 140. When an obstacle is detected outside the field, the work vehicle 100 avoids the obstacle or halts at the point. Outside the field, the position of the work vehicle 100 is estimated based on data output from the LiDAR sensor 140 or the cameras 120 in addition to positioning data output from the GNSS unit 110.

Hereinafter, an example of the operation of the work vehicle 100 performing automated travel inside the field will be described.

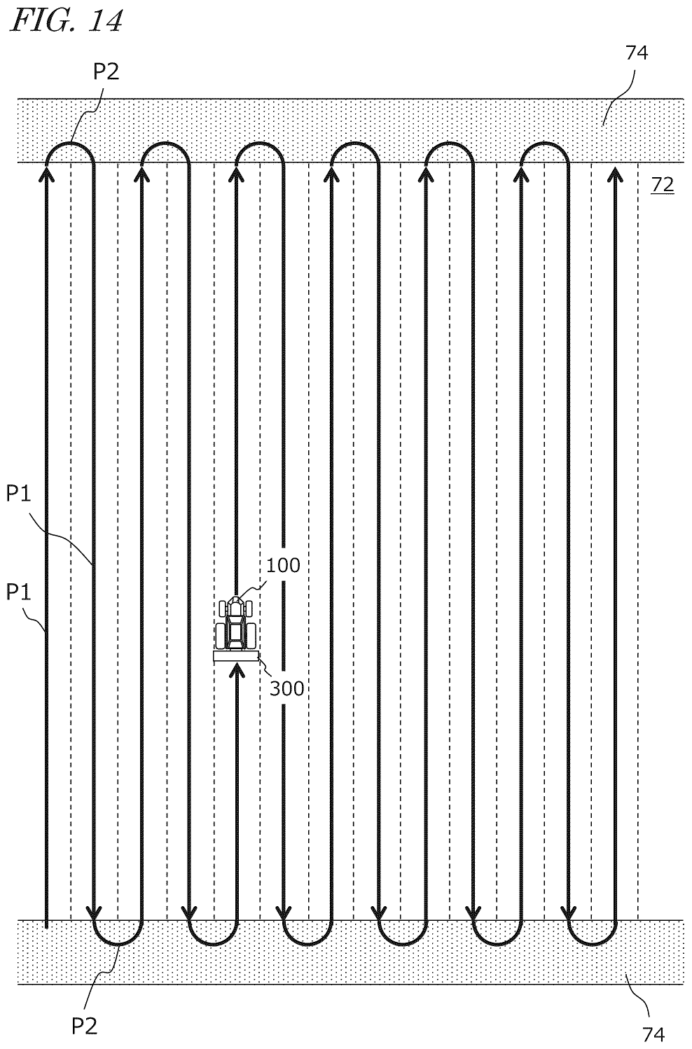

FIG. 14 is a diagram schematically showing an example of the work vehicle 100 automatically traveling along a target path in a field. In this example, the field includes a work area 72, in which the work vehicle 100 performs work by using the implement 300, and headlands 74, which are located near outer edges of the field. The user may previously specify which regions of the field on the map would correspond to the work area 72 and the headlands 74. The target path in this example includes a plurality of main paths P1 parallel to each other and a plurality of turning paths P2 interconnecting the plurality of main paths P1. The main paths P1 are located in the work area 72, whereas the turning paths P2 are located in the headlands 74. Although each of the main paths P1 in FIG. 14 is illustrated as a linear path, each main path P1 may also include a curved portion(s). Broken lines in FIG. 14 depict the working breadth of the implement 300. The working breadth is previously set and recorded in the storage 170. The working breadth may be set and recorded by the user manipulating the operation terminal 200 or the terminal device 400. Alternatively, the working breadth may be automatically recognized and recorded when the implement 300 is connected to the work vehicle 100. The interval between the plurality of main paths P1 may be set so as to be matched to the working breadth. The target path may be generated based on the manipulation made by the user, before automated driving is begun. The target path may be generated so as to cover the entire work area 72 in the field, for example. Along the target path shown in FIG. 14, the work vehicle 100 automatically travels while repeating a reciprocating motion from a beginning point of work to an ending point of work. Note that the target path shown in FIG. 14 is merely an example, and the target path may be arbitrarily determined.

Now, an example control by the controller 180 during automated driving will be described.

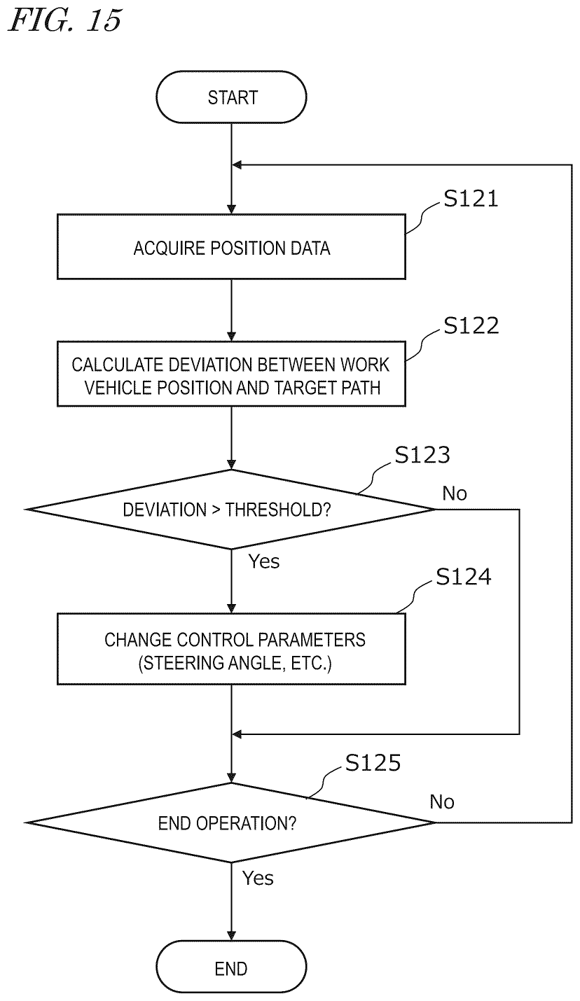

FIG. 15 is a flowchart showing an example operation of steering control to be performed by the controller 180 during automated driving. During travel of the work vehicle 100, the controller 180 performs automatic steering by performing the operation from steps S121 to S125 shown in FIG. 15. The speed of the work vehicle 100 may be, for example, maintained at a previously-set speed or adjusted according to the situation. First, during travel of the work vehicle 100, the controller 180 acquires data representing the position of the work vehicle 100 that is generated by the GNSS unit 110 (step S121). Next, the controller 180 calculates a deviation between the position of the work vehicle 100 and the target path (step S122). The deviation represents the distance between the position of the work vehicle 100 and the target path at that moment. The controller 180 determines whether the calculated deviation in position exceeds the previously-set threshold or not (step S123). If the deviation exceeds the threshold, the controller 180 changes a control parameter of the steering device included in the drive device 240 so as to reduce the deviation, thus changing the steering angle (step S124). If the deviation does not exceed the threshold at step S123, the operation of step S124 is omitted . . . . At the following step S125, the controller 180 determines whether a command to end the operation has been received or not. The command to end the operation may be given when the user has instructed that automated driving be suspended through remote manipulations, or when the work vehicle 100 has arrived at the destination, for example. If the command to end the operation has not been given, the control returns to step S121 and the controller 180 performs substantially the same operation based on a newly measured position of the work vehicle 100. The controller 180 repeats the operation from steps S121 to S125 until a command to end the operation is given. The aforementioned operation is executed by the ECUs 182 and 184 in the controller 180.

In the example shown in FIG. 15, the controller 180 controls the drive device 240 based only on the deviation between the position of the work vehicle 100 as identified by the GNSS unit 110 and the target path. Alternatively, a deviation in terms of directions may further be considered in the control. For example, when a directional deviation exceeds a previously-set threshold, where the directional deviation is an angle difference between the orientation of the work vehicle 100 as identified by the GNSS unit 110 and the direction of the target path, the controller 180 may change the control parameter of the steering device of the drive device 240 (e.g., steering angle) in accordance with the deviation.

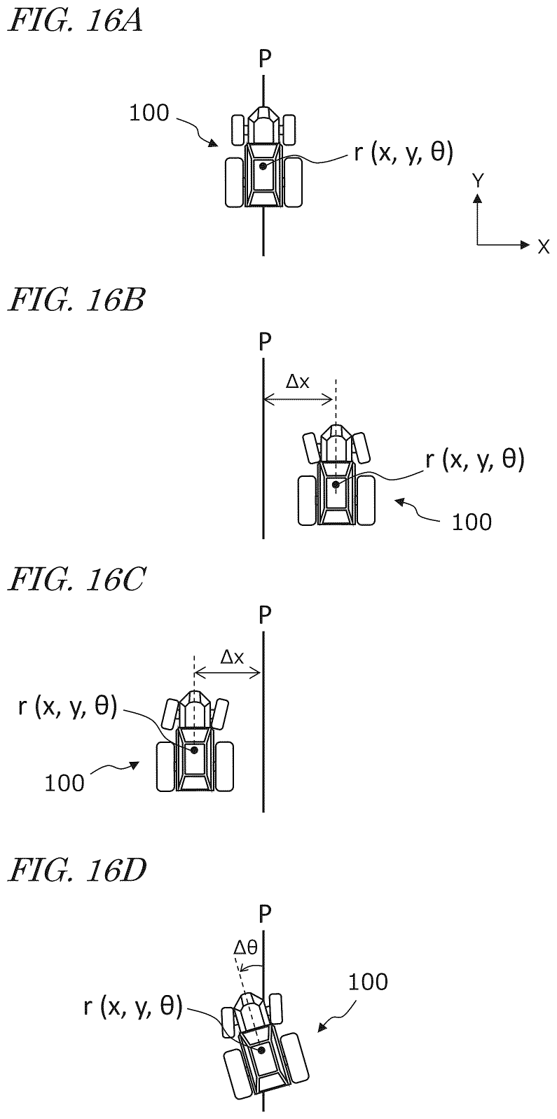

Hereinafter, with reference to FIGS. 16A to 16D, an example of steering control by the controller 180 will be described more specifically.

FIG. 16A is a diagram showing an example of the work vehicle 100 traveling along a target path P. FIG. 16B is a diagram showing an example of the work vehicle 100 at a position which is shifted rightward from the target path P. FIG. 16C is a diagram showing an example of the work vehicle 100 at a position which is shifted leftward from the target path P. FIG. 16D is a diagram showing an example of the work vehicle 100 oriented in an inclined direction with respect to the target path P. In these figures, the pose, i.e., the position and orientation, of the work vehicle 100 as measured by the GNSS unit 110 is expressed as r (x,y,θ). Herein, (x,y) are coordinates representing the position of a reference point on the work vehicle 100 in an XY coordinate system, which is a two-dimensional coordinate system fixed to the globe. In the examples shown in FIGS. 9A to 9D, the reference point on the work vehicle 100 is at a position, on the cabin, where a GNSS antenna is disposed, but the reference point may be at any arbitrary position. θ is an angle representing the measured orientation of the work vehicle 100. Although the target path P is shown parallel to the Y axis in the examples illustrated in these figures, the target path P may not necessarily be parallel to the Y axis, in general.

As shown in FIG. 16A, in the case where the position and orientation of the work vehicle 100 are not deviated from the target path P, the controller 180 maintains the steering angle and speed of the work vehicle 100 without changing them.

As shown in FIG. 16B, when the position of the work vehicle 100 is shifted rightward from the target path P, the controller 180 changes the steering angle so that the traveling direction of the work vehicle 100 will be inclined leftward, thus bringing the work vehicle 100 closer to the path P. At this point, not only the steering angle but also the speed may be changed. The magnitude of the steering angle may be adjusted in accordance with the magnitude of a positional deviation Δx, for example.

As shown in FIG. 16C, when the position of the work vehicle 100 is shifted leftward from the target path P, the controller 180 changes the steering angle so that the traveling direction of the work vehicle 100 will be inclined rightward, thus bringing the work vehicle 100 closer to the path P. In this case, too, not only the steering angle but also the speed may be changed. The amount of change of the steering angle may be adjusted in accordance with the magnitude of the positional deviation Δx, for example.

As shown in FIG. 16D, in the case where the position of the work vehicle 100 is not considerably deviated from the target path P but its orientation is nonetheless different from the direction of the target path P, the controller 180 changes the steering angle so that the directional deviation Δθ will become smaller. In this case, too, not only the steering angle but also the speed may be changed. The magnitude of the steering angle may be adjusted in accordance with the magnitudes of the positional deviation Δx and the directional deviation Δθ, for example. For instance, the amount of change of the steering angle (which is in accordance with the directional deviation Δθ) may be increased as the absolute value of the positional deviation Δx decreases. When the positional deviation Δx has a large absolute value, the steering angle will be changed greatly in order for the work vehicle 100 to return to the path P, so that the directional deviation Δθ will inevitably have a large absolute value. Conversely, when the positional deviation Δx has a small absolute value, the directional deviation Δθ needs to become closer to zero. Therefore, it may be advantageous to introduce a relatively large weight (i.e., control gain) for the directional deviation 40 in determining the steering angle.

For the steering control and speed control of the work vehicle 100, control techniques such as PID control or MPC (Model Predictive Control) may be applied. Applying these control techniques will make for smoothness of the control of bringing the work vehicle 100 closer to the target path P.

Note that, when an obstacle is detected by one or more obstacle sensors 130 during travel, the controller 180 halts the work vehicle 100. At this point, the controller 180 may cause the buzzer 220 to present an alarm sound or may transmit an alert signal to the terminal device 400. In the case where the obstacle is avoidable, the controller 180 may control the drive device 240 such that the obstacle is avoided.

The work vehicle 100 according to the present example embodiment can perform automated travel outside a field as well as inside the field. Outside the field, the controller 180 performs steering control and speed control along the target path (automated travel route) generated by the method described above. The controller 180 is able to detect an object located at a relatively distant position from the work vehicle 100 (e.g., another vehicle, a pedestrian, etc.) based on data output from the cameras 120 or the LiDAR sensor 140. The controller 180 generates a local path such that the local path avoids the detected object, and performs speed control and steering control along the local path. In this manner, automated travel on a road outside the field can be realized.

As described above, the work vehicle 100 according to the present example embodiment can automatically travel inside the field and outside the field in an unmanned manner. In the storage 170, an environment map of a region including a plurality of fields and roads around the fields, and a target path, are recorded. In the case of traveling on a road, the work vehicle 100 travels along the target path while sensing the surroundings thereof by use of the sensing devices such as the cameras 120 and the LiDAR sensor 140, with the implement 300 being raised. During travel, the controller 180 consecutively generates a local path and causes the work vehicle 100 to travel along the local path. This allows the work vehicle 100 to perform automated travel while avoiding obstacles. During travel, the target path may be changed in accordance with the state.

As described above, according to the present example embodiment, the actual travel route obtained when the work vehicle 100 is manually driven can be used for automated driving route generation. The automated driving route is generated by excluding actual travel routes obtained when the work vehicle 100 performs an action to avoid oncoming vehicles. Thus, the automated travel route is prevented from including inappropriate routes associated with avoidance actions, thus generating an appropriate automated travel route. In accordance with the automated travel route thus generated, the work vehicle 100 can, for example, execute automated travel on roads around the field appropriately.

The system for generating an automated travel route or performing automated driving control according to the above example embodiments can also be retrofitted to agricultural machines that do not have these functions. Such systems can be manufactured and sold independently of agricultural machines. Computer programs used in such systems can also be manufactured and sold independently of agricultural machines. Computer programs can be provided, for example, stored in a computer-readable non-transitory storage medium. Computer programs can also be provided as downloads via an electrical telecommunication line (e.g., the Internet).

The example embodiments and technologies of the present disclosure can be applied to systems for generating an automated travel route for agricultural machines, such as tractors, harvesters, rice transplanters, vehicles for crop management, vegetable transplanters, mowers, seeders, spreaders, or agricultural robots.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A route generation system for automated travel of an agricultural machine, the route generation system comprising:
a processor configured or programmed to generate an automated travel route of the agricultural machine; wherein
the processor is configured or programmed to:
acquire, from a vehicle that manually travels along a route that the agricultural machine is scheduled to travel automatically while recording a travel path, data representing the travel path; remove, from the travel path, a path associated with an avoidance action performed to avoid an oncoming vehicle; and
generate an automated travel route of the agricultural machine based on the travel path from which the path associated with the avoidance action has been removed.

2. The route generation system according to claim 1, wherein the processor is configured or programmed to:
acquire data of a video image taken by a camera mounted on the vehicle while the vehicle is traveling; and
detect the avoidance action based on the video image and determine and remove the path associated with the avoidance action from the travel path.

3. The route generation system according to claim 2, wherein the processor is configured or programmed to:
identify an oncoming vehicle approaching the vehicle from the video image; and
remove, as the path associated with an avoidance action, a path corresponding to at least a portion of a period from when the oncoming vehicle is identified to when the oncoming vehicle is no longer identified, from the travel path.

4. The route generation system according to claim 1, wherein the processor is configured or programmed to detect the avoidance action based on a change over time of a position of the vehicle indicated by the travel path, and determine and remove the path associated with the avoidance action from the travel path.

5. The route generation system according to claim 1, wherein the processor is configured or programmed to detect, as the avoidance action, at least one of traveling backward, changing direction, accelerating, or decelerating done by the vehicle to avoid an oncoming vehicle.

6. The route generation system according to claim 1, wherein the processor is configured or programmed to acquire position data sequentially output from a GNSS receiver mounted on the vehicle as data that represents the travel path.

7. The route generation system according to claim 1, wherein the processor is configured or programmed to generate, as the automated travel route, a route that is defined by a plurality of waypoints each including information on position and speed.

8. The route generation system according to claim 1, wherein the processor is configured or programmed to generate the automated travel route by performing a process of complementing a portion that has been removed from the travel path.

9. The route generation system according to claim 8, wherein the processor is configured or programmed to generate the automated travel route by complementing the portion that has been removed from the travel path with a straight complementing route.

10. The route generation system according to claim 8, wherein the processor is configured or programmed to:
display, on a display, the travel path with the path associated with the avoidance action removed; and
complement the portion that has been removed from the travel path in response to an operation by a user to confirm a complementing route.

11. The route generation system according to claim 1, wherein the processor is configured or programmed to perform a process of generating the automated travel route when generating a route for the agricultural machine to perform automated travel outside a field.

12. A route generation method for automated travel of an agricultural machine, the route generation method comprising:
acquiring, from a vehicle that manually travels along a route that the agricultural machine is scheduled to travel automatically while recording a travel path, data representing the travel path;
removing, from the travel path, a path associated with an avoidance action performed to avoid an oncoming vehicle; and
generating an automated travel route of the agricultural machine based on the travel path from which the path associated with the avoidance action has been removed.
